(19) United States
(12) Patent Application Publication
(10) Pub. No.: US 2004/0230495 A1
(43) Pub. Date: Nov. 18, 2004

(54) Computer systems and methods supporting on-line interaction with content, purchasing, and searching

(76) Inventors: Mikhail Lotvin, New York, NY (US); Richard Michael Nemes, Brooklyn, NY (US)

Correspondence Address: Richard M. Nemes, 2231 56th Drive, Brooklyn, NY, 11234-6840, US

(21) Appl. No.: 10/790,991

(22) Filed: Mar. 2, 2004

Related U.S. Application Data
(62) Division of application No. 09/329,143, filed on Jun. 9, 1999.
Application No. 09/329,143 is a continuation-in-part of application No. 09/294,761, filed on Apr. 19, 1999, now Pat. No. 6,178,407.
Application No. 09/294,761 is a continuation of application No. 08/826,550, filed on Apr. 4, 1997, now Pat. No. 5,907,831.

(51) Int. Cl. G09B 19/00; G06F 17/60

(52) U.S. Cl. 705/26

(57) ABSTRACT

The preferred computer apparatus and methods use computer technology in a unique way to motivate children to devote more time to educational and cultural enrichment, and encourages them to explore the appropriateness of various educational institutions that they may apply to for admission. In the preferred embodiment, educational material is provided at a child's local computer under control of a central computer system connected to it over a computer network. On completing a particular educational task, the child is rewarded with a certain number of points. Points that the child accumulates are stored centrally, and at least some of the points can be redeemed towards the purchase of goods and services offered through the system of the preferred embodiment by its commercial participants. The purchasing transactions are also administered by the central computer. Parents, preferably, use the system to support their children's purchasing activity financially and to select Is content available for presentation to the child. Users, both children and parents, can explore entrance requirements to colleges, universities, and other institutions, and school administrators can use the system to identify and locate appropriate applicants. The disclosed systems and methods can be used for purposes unrelated to education of children. For example, the disclosed system also supports limited on-line interaction with various products and services, rewarding users with discounts on those products and services.

### CROSS-REFERENCE TO RELATED APPLICATIONS

This is a continuation-in-part of application Ser. No. 09/294,761 filed Apr. 19, 1999, incorporated herein by reference in its entirety, which is a continuation of application Ser. No. 08/826,550, filed Apr. 4, 1997, entitled COMPUTER APPARATUS AND METHODS SUPPORTING DIFFERENT CATEGORIES OF USERS, which is now U.S. Pat. No. 5,907,831.

### BACKGROUND OF THE INVENTION

Today, computer technology has advanced to a great extent and continues to develop in giant steps. Powerful computer systems are available to consumers at reasonable prices. Computer networks, examples of which are the Internet and America Online™, are accessible at reasonable cost to all. Digital graphics, images, audio, video, and multimedia are widely available on discs and over networks. Software tools and languages, C++ and Java™, for example, are now powerful enough to allow software developers to build sophisticated applications, including distributed applications running on networks.

The processing, storage, multimedia, and networking capabilities of modern computers, such as personal computers, are perfectly suited for presenting educational and cultural content in an interactive, creative, and interesting fashion. However, educational and cultural applications of computers have not reached their full capacity and there is a need to develop computer technology that facilitates more extensive use of computers for educational and cultural purposes.

Furthermore, although certain reward-based systems have been disclosed, there is a need to provide a reward-based system that effectively encourages education and, as well, is applicable to other environments, such as commerce. In addition, advancement in education ought to result in admission to an appropriate college, graduate or professional school, or another institution; or in satisfactory employment. Yet, techniques for identifying appropriate educational institutions or appropriate jobs using computer technology (e.g., the Internet) are limited. They are typically limited to Web searches directed to finding the sites of appropriate institutions or classified on-line advertisements for employment. It is equally difficult for an educational institution to find appropriate applicants or for an employer to find appropriate employees. Thus, in general, there is a need for a system and method that enables a person to locate an organization and enables an organization to locate individuals.

### SUMMARY OF THE INVENTION

This invention relates to computer technology, including computer networks, and the preferred embodiments are directed to the implementation of computer technology for educational and cultural enrichment, the college application process, as well as to certain commercial applications.

The computer system and method of one preferred embodiment uses computer technology in a unique way to motivate children to devote more time to educational and cultural enrichment. It should be noted that although the preferred system is aimed at the education of children, as understood by persons skilled in the art, other applications of the disclosed system are also envisioned here.

In general, in the preferred embodiment, educational material is provided at a child's local computer (also referred to as a “user's computer”) under control of a central computer system. Children's local computer and a central computer are connected over a computer network. On completing a particular educational task, a child is rewarded with a certain number of points. Children's accumulated points are stored centrally. Points are based on criteria consistent with the educational material and, for example, are awarded based on the level of difficulty of a given task, the child's level of performance, and other considerations, such as progress demonstrated in a certain discipline over time. Points can be measured in any units, as understood by a person skilled in the art, including monitory units (e.g., dollars or fractions thereof.

Points that a child accumulates by completing educational exercises can be redeemed towards the purchase of goods and services offered through the system of the preferred embodiment by its commercial participants. Purchasing transactions are also administered by the central computer and can proceed in a variety of ways. For example, the child may order goods and services by selecting from menus presented by the central computer, which, in turn, orders the selected items by telephone, e-mail, mail, or otherwise from a vendor or distributor for delivery. As understood by a person skilled in the art, this includes arrangements with on-line shopping offerings of others (e.g., on-line catalogs of third parties), whereby the present system allows spending under a certain limit at such one or more on-line offerings. The central computer may also send a message to the local computer to print out certificates redeemable at participating vendors of goods and services. Also, points may be redeemed by downloading requested goods available in electronic form, such as software, games, music, and video. It is preferred that the offered goods and services be items desirable by the children so that the prospect of obtaining these items is a motivation for the children to diligently pursue the educational materials available in the system.

Parents have their own way of accessing the system of the preferred embodiment, and it is preferred that the parents' password not be given to a child, who has his own, usually different password. Parents preferably use the system for several purposes. First, parents support their children's purchasing activity financially. Preferably, the parent authorizes the system to periodically (e.g. monthly) allow purchases to be made through the redemption of the child's points, up to a certain limit, using the parents' credit card account, or makes other payment arrangements (e.g., though the use of electronic cash or direct account withdrawal). Preferably, part of the parents' payment is used as a periodic service fee for this service, while the rest is used for financing the redemption of points by the child for goods and services. Moreover, the parent can authorize a system-initiated increase in the purchasing power of the child—a “bonus”—by, for example, permitting certain advertising messages to be displayed to the child as the child uses the system.

In the preferred embodiment, the parent controls the content of the material available for presentation to the child. For example, the parent may limit the difficulty of educational presentations to be made to the child by specifying the age of the child, or by indicating an explicit desired level of difficulty. Also, other considerations, such as whether to emphasize mathematics, science, literature, music, art, etc., can be under the control of the patent. Furthermore, the parent may exclude certain categories of goods from being made available to the child for exchange of earned points by the child. The parent may also restrict the available materials with a goal towards child's acceptance to desired colleges or universities.

In this consumer-oriented society there are desirable commercial items—deemed “cool”—that children of various ages want, such as popular games, toys, movies, clothing, admission tickets to arcade games and sporting events, etc. Parents typically spend money to purchase these items for their children. These items, though usually innocent, frequently do not bring intellectual, cultural, or developmental benefits to the children. Often, such items are advertised and promoted through mass media that are not designed to educate, enlighten or develop, such as television, which at best serve as passive entertainment. Parents, on the other hand, usually prefer spending money on educational, cultural, and developmental products that facilitate the intellectual and emotional growth of their children.

One aspect of the present invention uniquely fulfills the desires of parents to facilitate their children's intellectual development, and, at the same time, provides children with access to the goods and services they most desire. Although this goal is accomplished by the preferred system, other useful applications with different goals can be built by persons skilled in the art on the basis of this disclosure.

Because one of the benefits of better education is the greater possibility of attending a better college or other educational institution, the preferred embodiment also provides an interface between its users and school administrators. It permits rewards (e.g., points) received in connection with the educational exercises discussed above to be applied towards college or other school applications, and it also allows a college or school administrator to credit points, including monetary credit, to users'accounts to encourage selected students to apply to their particular institution. The preferred embodiment, in addition, then, provides a comprehensive system for potential applicants and administrators to ascertain admission-related information. The system is also useful for potential job applicants and employers, as well as for an individual, in general, to select an organization and for an organization to find and select individuals. Although, preferably, this service is integrated with the service discussed above, in other preferred embodiments it can be implemented as a stand-alone service uncoupled from the service discussed above, as understood by a person skilled in the art. And, as noted, it can also be used for purposes that are marginally or totally unrelated to education.

It is understood that “parent” is not necessarily a biological parent, custodian, or adult authority, and can be anyone who performs the tasks identified herein with “parent.” Similarly, the “child” is not required to have a biological, subservient, or dependent relationship to the parent and can be anyone who performs the tasks identified herein with “child.” The “central computer system” (also referred to as the “central computer,” or “central facility”) may include one or more physical computers as determined by specific implementation trade-offs, given the constraints of a particular implementation, as known in the art. In some embodiments, the central computer may comprise computers loosely interconnected by a computer network.

Educational materials, presentations, and exercises refer to content used in the preferred embodiment. Preferably, this content includes a variety of educational and cultural presentations and exercises, which include standard textbook-like exercises, spelling, mathematics, history, and geography lessons, reading comprehension, reading an article on a subject and answering questions, standardized tests, scientific material and problems, and all other content used for educational purposes. Other forms of educational and cultural materials can be provided as well, such as learning about music, art, and theater—through multimedia presentations, for example—and playing chess. Competitions, in which winning participants earn points, are also included in the definition. In fact, educational materials include any and all educational and cultural exercises and material intended to educate, enlighten, train, or develop. A person skilled in the art will appreciate that in embodiments for purposes unrelated to education, other relevant content can substitute for the educational content of the preferred embodiment. For example, such embodiments may include commercial applications wherein the content relates to products or services and the points represent discounts for the products or services.

In other embodiments, terms such as “parent,” “child,” and “educational materials and presentations ” can have different meaning, and can be entirely unrelated to the education of children. For example, a company's management can sponsor employee training based on the system of this invention. In such an embodiment, the company plays the role of “parent,” paying for on-line courses, and employees play the role of “children,” who earn college credit for their participation. The company finances educational courses and optionally exercises some control over the selected curriculum; employees take courses, which constitutes their participation. “Educational materials” include course lectures and materials, assignments, and examinations, while earned “points” are credits redeemable for college degrees at participating educational institutions.

Educational materials can be provided to the child in a variety of ways. They can be available on the central computer of the service of this invention, for example, or provided by third party content providers. To use them, the child may interact directly with the remote computer of the service, using Internet, cable, or another network, and they may be downloaded to the child's local computer, so that only the resultant tally of earned points is subsequently provided to the central computer for storage. Another way that the materials can be provided is on a disk, such as a CD-ROM, so that only the results of the interaction with the child are provided to the central computer.

A user's computer is any appropriate data processing device available to participants in the service provided by the preferred system. In the preferred embodiment, it is a conventional personal computer with a modem (or other network connection), a CD-ROM drive, hard-disk drive, one or more diskette drives, a central processing unit, random access memory, color monitor, keyboard, a graphical interactive input device, such as a mouse, and printing devices, such as laser and ink-jet printers. As understood by a person skilled in the art, a network may include any suitable network (e.g. telephone, cable, or wireless network) or a combination thereof. “User computers” (or “local computers”) also can be other computer devices that may be used by users of this invention, such as, computer terminals with sufficient intelligence and interfaces, computer workstations, Internet appliances and TV's, and other computer devices having sufficient processing, storage, input, and display capabilities.

### BRIEF DESCRIPTION OF THE DRAWINGS

The invention will be better understood when taken in conjunction with the following detailed description and accompanying drawings, in which:

FIG. 1 illustrates computer architecture and organization of the preferred embodiment;

FIG. 2 illustrates the flowchart of log-in procedure;

FIG. 3 illustrates the flowchart of parent dialogues;

FIG. 4 illustrates the flowchart of child dialogues;

FIGS. 5A and 5B illustrate the flowchart of a general scenario of an educational presentation;

FIG. 6 illustrates the flowchart of the purchase subsystem;

FIG. 7 illustrates the flowchart of the new child account dialogue;

FIG. 8 illustrates the flowchart of the parental preferences dialogue;

FIG. 9 illustrates the flow of modify child account dialogue;

FIG. 10 illustrates the flowchart of monitoring child's progress;

FIG. 11 illustrates the flowchart of the feedback manager;

FIGS. 12A and 12B illustrates an Entity-Relationship (E-R) diagram providing an example of data organization in the system database;

FIG. 13 illustrates the architecture and configuration of the administrative subsystem;

FIG. 14 illustrates the communication network configuration of the preferred embodiment of the present invention;

FIGS. 15A and 15B illustrate a flowchart of an alternative embodiment implemented wholly at the local computer;

FIGS. 16A, 16B, and 16C illustrate examples of the present system and method employed for commercial applications;

FIGS. 17A and 17B, illustrate a preferred method and system for identifying an educational institution, and more generally, for an individual in locating an organization;

FIGS. 18A illustrates a preferred method and system for an educational institution for identifying potential applicants and, more generally, for an organization in locating individuals;

FIG. 18B illustrates a procedure for evaluating the compatibility of a student with a school, and more generally, of an individual with an organization;

FIG. 19 illustrates one technique of providing advertisements to users in which advertisers contribute financially to the users;

FIGS. 20A and 20B illustrates expert system and method for determining educational carrier path leading to school acceptance.

### DETAILED DESCRIPTION OF THE PREFERRED EMBODIMENT

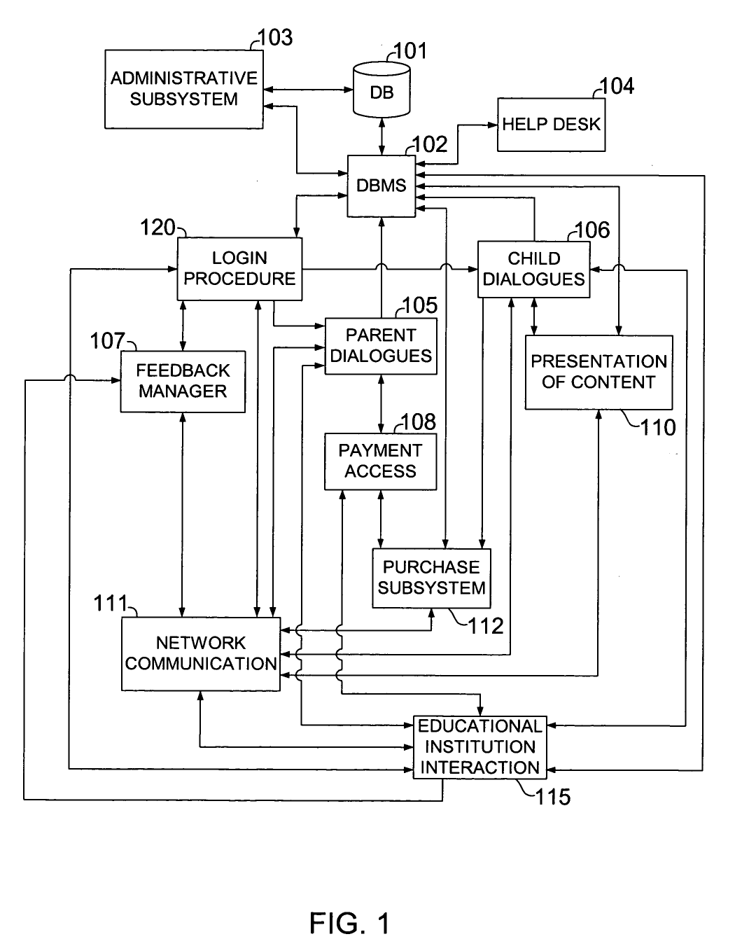

FIG. 1 illustrates the overall architecture of the central computer system in the preferred embodiment. Block 101 illustrates the database storage subsystem. In the preferred embodiment, it is one or more magnetic storage disks organized to support the information storage and retrieval needs of the system disclosed below. Such disks are known in the art and are available commercially. Also, other physical storage media, e.g., optical storage, may be used, as known in the art. In the preferred embodiment, the entire database storage system is located at the central computing facility. A person skilled in the art will appreciate that in other embodiments it can be distributed throughout different sites, including storage at users' local computers. In the preferred embodiment, each of the remaining blocks shown in FIG. 1 are software modules that execute on a computer or computers located at the central facility. (In other embodiments, some or all of these modules can execute in a distributed computing environment, including users' local computers.)

Block 102 depicts the database management system (DBMS) that provides capabilities typical for such a system, including data retrieval, insertion, and modification, as well as database queries, as is known in the art. It is used in conjunction with the file system capabilities provided by the native Operating System. Preferably, some data, as described below, is not managed by the database management system but is instead handled through the Operating System's file system directly. Preferably, the database management system 102 is a relational database management system organized to support the data needs of the system disclosed herein. (In other embodiments, other data models, e.g., “hierarchical” and “network,” may be used. Direct use of the computer's file system capabilities, which are provided by the computer's native Operating System, is possible in some embodiments as well, which could obviate the need for a database management system altogether.) Preferably, database management system 102 is based on commercially available database management software. Such software is presently available, for example, as ORACLE®'s line of database management systems. Specific implementation trade-offs should be considered in selecting the database management system.

Administrative subsystem 103 manages the resources of the system and, as illustrated, is interfaced to the database management system 102. The administrative subsystem 103 is used by the system administrator(s) and management for monitoring performance; fraud detection; performance tuning adjustments; adding, deleting, and modifying content and presentations; modifying user data in the database; billing; and system backup and recovery.

The help desk subsystem 104 supports human operators who communicate with users. The operators deal with problems and concerns of users by answering questions, providing suggestions, and, addressing users' concerns in any other way. The help desk subsystem is also interfaced to the data base management system 102 to obtain up-to-date information about the users and the system. The help desk subsystem software includes capabilities for querying and modifying the system database (block 101) through the database management system. Preferably, operators interact with users by voice over telephone and/or interactively through computer-to-computer communication. The operators are provided with networked personal computers interfaced to the database and with telephones. They receive telephone calls and e-mail distributed in accordance with operator queues as known in the art. (In other embodiments, other methods of communication may be used, such as mail and facsimile.)

The log-in subsystem 120 includes software supporting the log-in procedure that is used to verify passwords of users who request access to the system, as well as software for opening new user accounts, as discussed in more detail subsequently. On a successful log-in, four subsystems of the system are available to support interaction with the user after the log-in subsystem 120 hands-off control to one of the four. These four subsystems encompass: parent dialogues, block 105, for facilitating interaction with the parent, as described in more detail below; child dialogues, block 106, for facilitating interaction with the child, as described in detail below; feedback manager, block 107, for facilitating interaction between users and the system's management, as discussed in more detail below; and educational institution interaction subsystem 115 as discussed in detail below. The feedback manager 107 is available to parents, children, and educational institution administrators whereas, preferably, the parent and child dialogues subsystems are accessible, respectively, by parents only and by children only.

The payment access subsystem, block 108, is implemented using secure software, as known in the art, for handling payment transactions. Preferably, payments are handled through credit cards, so that the payment subsystem supports interactions with the credit card company of the parent. In other embodiments, however, it may support other forms of payment, such as e-cash (electronic cash), account withdrawal, ordinary payment by cash, check, or money order, and invoice billing.

The presentation of content subsystem, block 110, preferably delivers educational materials during the child dialogues. This subsystem provides educational materials to the child in response to inputs received from the child during the child's interaction with the system. In addition, the presentation of content subsystem 110 performs functions connected with the awarding of points on completing an educational assignment.

In the preferred embodiment, the educational materials delivered to the child by the presentation of content subsystem 110 can be located centrally, i.e., at the database (block 101) of the system, in which case the educational presentations subsystem retrieves and activates these materials. Preferably, the central computer retrieves software from the database (block 101) and downloads it to the user's computer, which executes it and then returns the results to the central computer. In another preferred embodiment, the educational material software can be executed by the central computer, or the execution can be interleaved between the central and local computers. In addition to being centrally located, however, educational materials can be wholly or partially resident on an appropriate storage medium, such as magnetic or optical storage, located locally at the user's computer.

In the case that the presentation of the educational materials is executed locally, the child chooses a particular presentation, which the presentation of content subsystem uses to search the database (block 101 of FIG. 1). On locating the information associated with the chosen presentation for the particular child and finding an indication that the chosen presentation resides locally at the user's computer, control is handed to a portion of educational presentation subsystem 110 software that executes locally on the user's computer. If the associated data indicates that software that executes on local computers is stored at the central facility, the central facility retrieves this software from the database, downloads it to the local computer, and then transfers control to the locally downloaded software.

As understood based on this disclosure by a person skilled in the art, one preferred implementation is the use of the Internet web pages and browser technology.

The locally running software manages the presentation of the educational material and may administer any examinations that may be associated with the presentation in order for the child to earn points. On completion, the locally executing software establishes computer communication with the central computer to transmit the results of the presentation and interaction, typically the number of points earned, if any, by the child, for correlation and aggregation with the child's accumulated point total. If the locally-running software had been downloaded from the central computer, it is preferably deleted following termination of its execution.

Other content—“educational materials” in the preferred embodiment—can be provided by third-party content providers, in which case the database 101 may contain only an indication that these presentations are available, along with the network location of such material. The third party content can either be downloaded and executed locally at user's computer or executed at the third-party computer.

The purchase subsystem 112 manages the purchase of goods and services based on the points accumulated by the child. It is responsible for presenting appropriate menus of offered goods and services that may be optionally based on the parents' preferences; taking the child's purchase requests; ordering chosen products and services from appropriate vendors, distributors, and service providers; printing a coupon that can be exchanged for the chosen goods or services if appropriate; and downloading a electronic product, or accomplishing the transaction otherwise. As understood by a person skilled in the art, this includes arrangements with on-line shopping offerings of others (e.g., on-line catalogs of third parties), whereby the present system allows spending under a certain limit at such one or more on-line offerings. In addition, the purchase subsystem 112 adjusts the number of points available for further purchases following a purchase. To bill the parents' credit card account for purchases made by the child, this subsystem is interfaced to the payment access subsystem 108. In the preferred embodiment, the purchase subsystem 112 is a software module executing wholly on a computer or computers at the central facility. (In other embodiments, some-or all of this software can execute-at various sites, which may include users' local computers.)

The network subsystem 111 handles computer communication with users and third party content providers by providing access to appropriate computer networks. Also, participating commercial entities may be connected to these networks for electronic ordering of goods and services. These communications can take place either on the publicly available Internet, using protocols such as TCP/IP, or on private networks. In the preferred embodiment, this subsystem interacts with complementary communication software executing on users' local computers, third party content providers' computers, participating commercial entities' computers, and computer network servers. (In other embodiments, different arrangements may be found as known in the art.)

The educational institution subsystem 115 provides users, which can include both children and parents as well college or other educational institution (or even non-educational institution) administrators, with query, searching and other capabilities as discussed subsequently relating to selecting an educational institution by a potential applicant and selecting potential applicants by an educational institution.

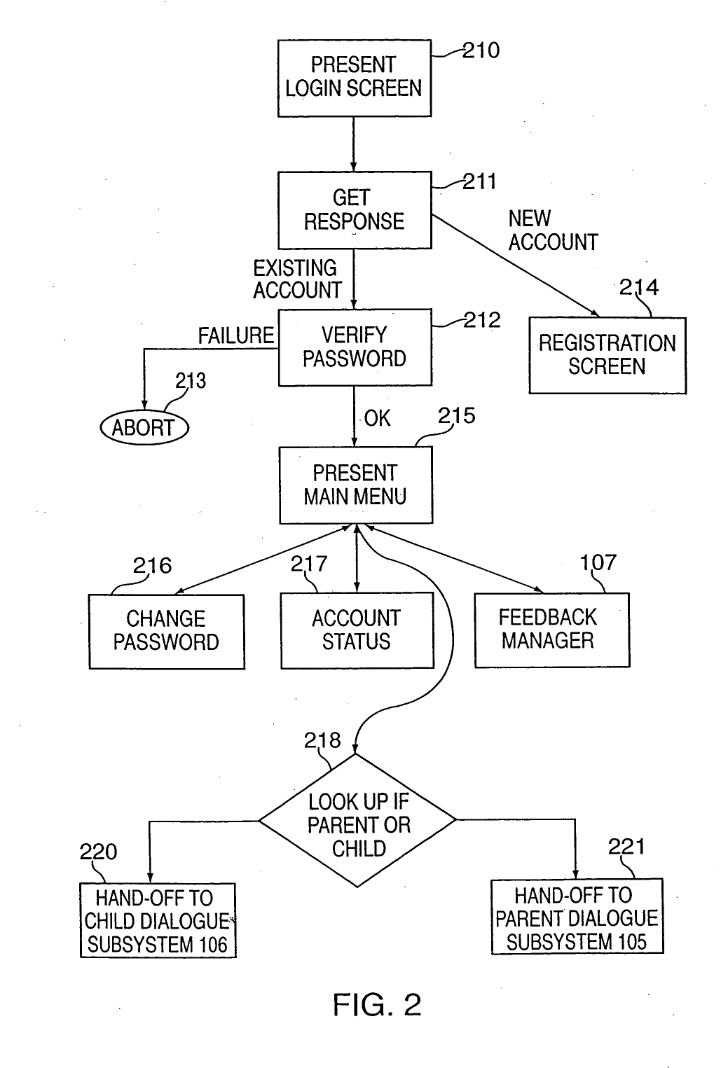

FIG. 2 depicts the log-in procedure of the preferred embodiment, which is illustrated as block 120 of FIG. 1. At block 210, the user gains access through the communications network to the central computer and is then presented with the log-in screen, in which the system requests the user to enter a unique identifier, known in the art as a “password,” or indicate that a new user registration is desired. The user provides the response at the following block 211 at his computer. In the preferred embodiment, in which the services provided by the invention are controlled by the central computing facility, the response is then transmitted to that central computing facility. The user may enter his password if he is already registered as a user of the system with an existing account, or he may indicate that he wishes to establish an account on the system and register as a new user.

When a new user wants to establish an account, he is presented with a registration screen, shown as block 214, that allows him to enter necessary information, which is then stored centrally at the database (block 101 of FIG. 1). Initial registration is typically done by the parent, who provides credit card or other payment information, which is verified before registering passwords for the users (i.e., parents and children) associated with the particular account on the system. (The credit card account can be verified electronically, or alternatively, using the assistance of an operator.) Typically, at least two passwords are established for a given account: one for the parent and one for each child associated with the parent. In the preferred embodiment, the parent cannot use the child's password to, for example, force-the child to redeem points on specific goods and services desired by the parent. Similarly, a child should not know his parent's password, to prevent the child from changing the payment limit and other preferences established by the parent. Preferably, during registration at block 214, the parent also provides initial preferences regarding the educational material and purchase guidelines for his child, which is detailed below. The preferences can be subsequently changed should the parent so desire. Preferably, these preferences include the amount of money that can be charged/withdrawn for the child's purchase of goods and services each period (e.g., monthly) and the difficulty and sophistication of educational material to be presented to the child. The preferences may also include the type of goods and services that the child may purchase when redeeming points; the type of material to be presented to the child, for example, verbal, mathematical, literary, artistic, scientific, and musical; and the allowing or disallowing of certain advertisements to be presented to the child during the course of the child's interaction with the system. Other preferences can be included in other embodiments.

When the user enters the password, it is provided to the password subsystem, shown as block 212, where it is verified using known means with reference to the collection of known passwords. In the preferred embodiment, the collection of known passwords is stored centrally in the database, block 101 of FIG. 1. If the password is invalid, the system provides a message to this effect and terminates the user session at block 213. Otherwise, the password is valid and the system provides the general presentation screen, shown as block 215, which in the preferred embodiment is a menu of options from which the user may choose. In the preferred embodiment, this menu includes options to change the password (block 216), view the current status of the account (block 217), send feedback messages (suggestions, complaints, and comments) to the system management (block 107), or proceed directly to the parent or child dialogue. (In other embodiments, other options may be included in addition to, or in place of, the ones shown here.) As indicated by the arrows pointing back to block 215, blocks 216, 217, and 107 return control to the general presentation screen on completion of their tasks. Finally, the log-in procedure hands off control to either the child dialogue subsystem (block 220) or the parent dialogue subsystem (block 221), depending on whether the test in decision box 218 indicates that the user who has just logged in is a child or a parent, respectively. In the preferred embodiment, this hand-off does not result in return of control directly to the log-in procedure, as was the case with blocks 216, 217, and 107 described earlier. The steps of the log-in subsystem relating to school administrator's log-in procedure are not illustrated on a separate drawing, because based on the above disclosure, the above-discussed procedure can be easily adapted for the administrator's log-in.

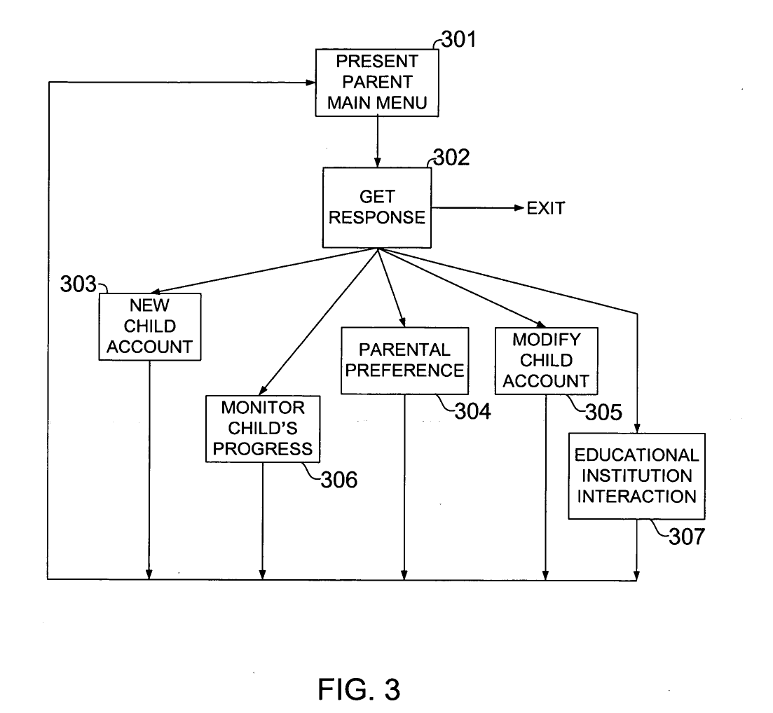

FIG. 3 depicts the parent dialogues subsystem in the preferred embodiment. As shown in FIG. 3, the parent is presented with a high-level presentation menu at block 301. In the preferred embodiment, the central computer receives and interprets the parent's response at block 302. Illustratively, the system initiates the following capabilities based on the response from the parent: the parent can opt to access the educational institution selection subsystem (described in further detail below), see 307, open a new child account at block 303, elect to modify an existing one at block 305, modify parental preferences at block 304, or monitor a child's or children's progress at block 306.

The functions performed at block 303 include giving the parent the opportunity to specify, for example, financial (e.g., credit card) information, preferences regarding educational presentations, and allowable purchases when the parent's child or children redeem points. The functions performed at block 305 include giving the parent the opportunity to modify information unrelated to educational presentation preferences that was previously presented to the system by the parent at block 303 or block 305.

At block 306, the parent can receive information regarding his child's or children's progress. Illustratively, at block 306 the system provides data to the parent about his child's or children's latest activities on the system, as well as other data, such as statistics about his child's or children's progress over time and his child's or children's strengths and weaknesses. In addition, the parent can view feedback messages sent by his child or children, and can communicate with his children, and, in other embodiments, with other users as well, using e-mail facilities as known in the art. Other useful data can include, for example, aggregate statistics (e.g., performance averages) of other children at comparable educational or age levels, and comparisons of the parent's child or children with other children. Other data presented to the parent at block 306 can include his child's or children's accumulated point totals, purchase history, educational presentation history, and schools that the child has applied to. At block 306, the parent may also view creative works of art, such as, for example, electronic drawings, music, stories, poems, and other multi-media creations, produced by his children. (In other embodiments, the parent can view creative works produced by users other than his children, and may even have the capability of contributing creative works to the system for presentation to other users or for inclusion in the library of educational presentations maintained by the system.) The information presented to the parent at block 306 is stored in the system database (block 101 of FIG. 1), or can be computed from data stored there.

At block 304, the parent is provided with a screen for modifying parental preferences regarding educational presentations to be made to his child or children. This includes specifying the child's level of difficulty and preferred educational materials. This may also include the parent allowing or disallowing the presentation of advertisements to the child and, if allowing advertisements, specifying categories of ads that may or may not be presented (e.g., allowing ads for toys that are only of a nonviolent nature, or prohibiting ads for candies and sweets). In some embodiments, the parent may also restrict the child's ability to apply and/or browse selected schools in the educational institution interaction subsystem 115. Conversely, parent can encourage child to view information about certain schools at the educational institution interaction subsystem by offering point rewards in exchange.

When the parent completes interaction with the system at blocks 303, 304,305, 306, or 307 control returns to the presentation menu at block 301, where the parent may select another function or elect to exit.

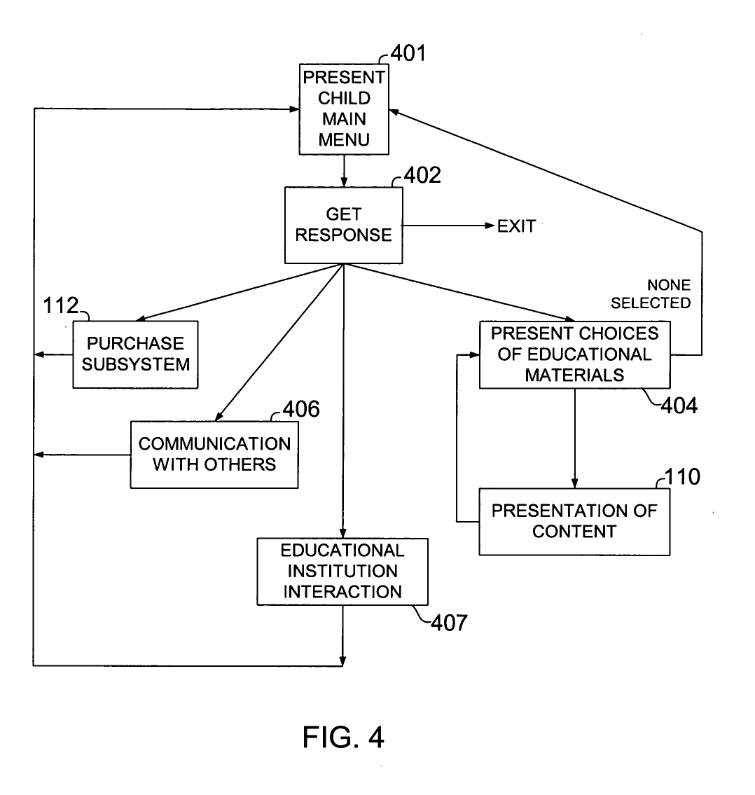

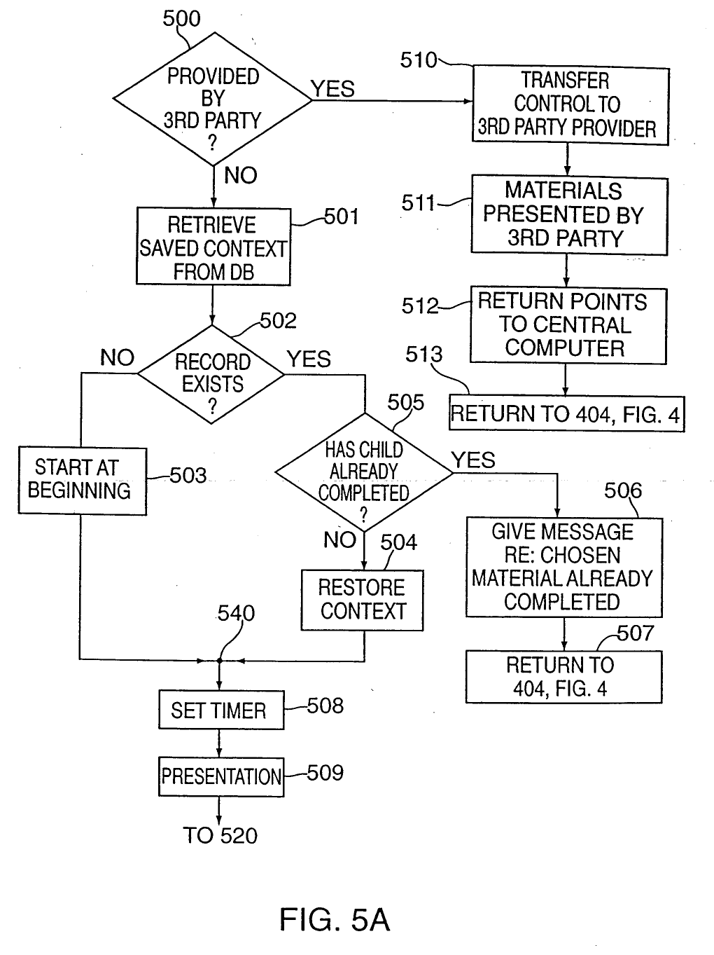

FIG. 4 depicts the child dialogues subsystem in the preferred embodiment. As shown in FIG. 4, the child is presented with a high-level menu at block 401. The central computer of the preferred embodiment receives and interprets the child's response at block 402. Illustratively, the system can initiate the following capabilities based on the response from the child: the child can opt to access the educational institution selection subsystem (described in further detail below), see 407, the child can request presentation of educational material at block 404, elect to make a purchase through a redemption of points at block 112, or communicate with other participants of the system at 406.

If the child's response at block 402 was a request for educational material, control proceeds to block 404, where the child is given a selection of activities, which are referred to here as “educational presentations.” For example, these activities may include presentations that are followed by—or interleaved with—questions, lessons, homework, exercises, problems, reviews, assignments, projects, examinations, quizzes, puzzles, standardized tests, competitions, tournaments, and contests. The presentation material can be in the area of literature, mathematics, science, art, language, music, technology, games, such as chess, or any other field as desired in a particular embodiment. As indicated, in other contexts other suitable material would be used. In the example described above concerning corporate employees, “educational presentations” would be professional courses and associated examinations, technical or vocational training, and the like. Selection of content, which is educational in the preferred embodiment, depends on the specific embodiment of the system, and need not necessarily relate to education per se.

Based on the child's selection at block 404, a specific presentation identified to the system at 404 is provided at block 110, as described in further detail below. This presentation can be provided by downloading software to the user's computer from the central computer, interacting locally, and then sending the results of the interaction in a summary form to the central computer; directly interacting with the central computer; accessing a third party provider's computer and then sending the results of the interaction in an summary form to the central computer; downloading software from a third party provider and then sending the summary results to the central computer; or using content that is already stored at the user's computer and then sending the results to the central computer. Other modes of remote interaction with users that are known in the art are also possible, and include combinations of the methods mentioned above. Upon completion of the given presentation at block 110, control returns to block 404 where another presentation can be selected if so desired. If none are selected control returns to block 401.

Considering another choice at block 402, the child can choose to make a purchase by redeeming points through the purchase subsystem at block 112. The purchase subsystem at 112 provides necessary information to the child, such as the number of points accumulated by him and how many points may be redeemed, in addition to giving him the capability to transact a purchase. Available products together with their prices in points are organized as lists of items, or can be provided as a virtual shopping mall as known in the art. The interaction with the child at the time of product selection and purchase is described in more detail below. The products or services can be delivered to the child in various ways: by sending e-mail to product and service providers, by printing coupons at the child's computer, by downloading to the user's computer a software, music, or art product, and the like. To determine product information, e-mail or Internet connection to vendors may be available from the purchase subsystem in some embodiments. As understood by a person skilled in the art, this includes arrangements with on-line shopping offerings (e.g., on-line catalogs), whereby the present system allows spending under a certain limit at such one or more on-line offerings.

The child may choose to communicate with other users of the system as illustrated at 406. Services such as discussion groups, electronic bulletin boards, and intra-system e-mail may be provided here as known in the art.

When the child completes interaction with a selected part of the child dialogue subsystem, control returns to the presentation menu at block 401, where the child may select another function or elect to exit.

Preferably, all displays provided to users have space available for advertisements, in order to increase the system's revenue. Alternatively, only certain displays selected by the operator of the system of a particular embodiment may contain advertisements. Schools, for example, that participate in the service of the educational institution interaction subsystem may choose to advertise. Methods and systems for including advertisements in on-line or downloaded material are known in the art, and can be implemented using appropriate programming languages and tools, such as Java. In some embodiments, a parent may control advertisers' access to displays shown to his child. Selection of advertisement based on parental preferences can be done by grouping advertisements into appropriate categories, for example, food, entertainment, toys, and the like, and precluding advertisement in those categories prohibited by the parent.

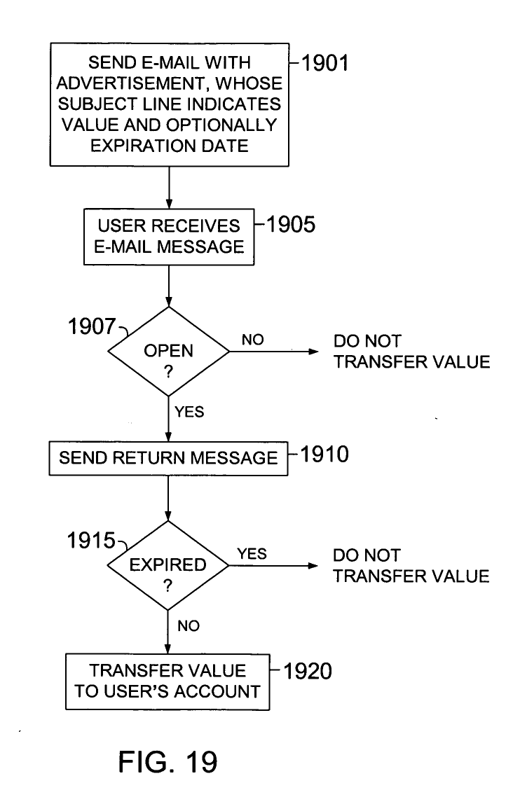

In addition to conventional electronic advertisement, advertisers can expose users to advertising materials using the technique illustrated in FIG. 19. At 1901, the entity providing the advertisement, sends bulk e-mail containing the advertisement material to users (e.g., children in the present system). Such e-mail transmission should be in compliance with the applicable laws and regulations relating to bulk e-mail transmission. It should be noted that this technique of providing advertising materials, as illustrated in FIG. 19, is not limited to the framework of the preferred services discussed herein, but can be used with e-mail transmission to any person as long as the transmission complies with the relevant laws and regulations. The subject line of the transmitted e-mail, which is displayed to the user before the e-mail is opened and its message can be read, contains a monetary value, for example a given number of points, which can be represented as the U.S. currency, e.g. dollars and fractions thereof. Also, an expiration date (and/or time) can be provided in the displayed portion indicating after which date (and/or time) the e-mail cannot be opened for the indicated monetary value. An identification of the advertised product or service may also be optionally provided in the displayed portion. At 1905, the user receives this advertisement e-mail, such that its monetary value and possibly the expiration date are displayed. As noted, the message of the e-mail is not displayed until the e-mail is opened by the user. The user may decide to open the e-mail, see 1907. Then, after the e-mail has been opened, a return message is generated and returned to the originator of the email (i.e., the entity supplying the advertisement), indicating that the e-mail has been opened and identifying the user. See 1910. The user's account may also be included in the return message or it may be ascertained by the entity supplying the advertisement based on the identity of the user. In response to this return e-mail, the entity supplying the advertisement transfers the monetary value indicated in the subject line of the e-mail to the account of the user, provided that the response has been received before the expiration date. See 1915 and 1920. If the e-mail has not been opened or has been opened after the expiration date, no value is transferred to the user's account.

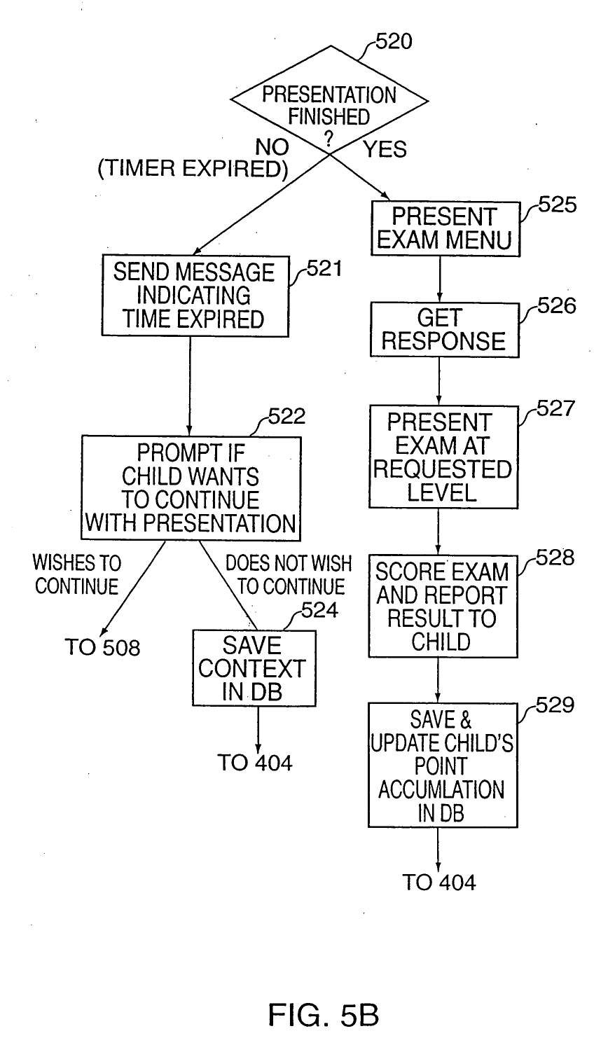

FIGS. 5A and 5B illustrate a typical scenario of an educational presentation in the preferred embodiment. At block 500, the system determines, based on information stored in the database (block 101 of FIG. 1), where the requested presentation material is stored. It might be stored in the system database, on the user's local computer, or at a third party provider's site. (In some embodiments, it may be stored at several places simultaneously or its constituent parts may be distributed across various sites.) If a third party provider is not involved, the presentation proceeds under the control of the central computer. In this case, control proceeds to block 501, where the system retrieves the child's previously saved context for the requested presentation from the database. The context is typically saved when, for any reason, the presentation is interrupted and the child exits before the presentation completes. The context records the state of the presentation at the moment of interruption. When a child completes a presentation, the fact that it completed is saved as the context, so as not to repeat the same presentation.

At block 502, if the saved context is not found for the given child-and the requested presentation, i.e., this is the first time that the child has requested this presentation, control proceeds to block 503 where the presentation is started from its beginning. If the saved context is found at block 502, the system checks at block 505 whether the child has already completed the presentation. If so, since it is not productive for the child to view the same presentation again, the system issues an appropriate message at block 506, and at block 507 control returns to block 404 of FIG. 4. Otherwise, the system restores the presentation substantially to the point of interruption at block 504 based on the context retrieved from the system database at block 501. (In some embodiments, it may be possible for a child to view a presentation more than once).

FIGS. 5A and 5B depict educational presentations that generally contain two parts: an educational display and an examination. For example, the educational display might consist of a chapter of a novel, and the examination might be a series of questions related to the reading. Some presentations might consist of only one part, i.e., only the display or only the examination. This might occur, for example, when the child reads a chapter of a novel from a book in his possession, views a live theatrical performance, or listens to a musical selection on the radio or television, and uses the system of the invention only for the examination component of the presentation. In such cases, that portion not required is omitted.

The examination component may be a traditional test, such as a collection of mathematics problems, or can be a more interactive exercise, such as a chess game or a crossword puzzle. A person skilled in the art will be able to introduce variations on the presentations described here, such as interleaving the display and examination components, or using other known variations.

At block 508, a software timer, which provides a time limit on the educational presentation, is initialized, and at block 509 the presentation itself is provided to the child. The presentation may be written material, such as a magazine article or a chapter of a textbook, or can be graphical or musical material, such as a set of paintings or musical selections along with explanatory instruction, or it can be any other content as known in the art. Optionally, a statement specifying the goals of the presentation may be provided as part of the display component or part of the examination component, depending on the application. If the display component is to be omitted, the timer can be initialized to zero; if no time limit is to be imposed on the display component, the timer can be initialized to a very large number. Control exits block 509 when the display completes or the timer expires, whichever comes first.

Thereafter, control proceeds to block 520 from where, based on whether the child has completed viewing the display or the timer has expired, a control branch is made either to block 525 or block 521. In the case that the timer expired, a message is sent to the child indicating that time is up, and the system requests feedback from the child regarding how to proceed. If the child wants to continue with the interrupted presentation, control returns to block 508 where the child can continue the presentation; otherwise the system saves the current context in the system database and control returns to block 404 of FIG. 4.

When the display component of a presentation is completed by the child, control transfers to block 525, where the child begins the examination component of the presentation, which is the portion of the presentation during which the child can earn “points.” At block 525, then, the child is presented with an examination menu. Optionally, the child may select the difficulty level of the examination (more difficult levels offering potentially more points). The system receives the child's response of an examination selection at block 526, and, based on the selection, an examination of appropriate difficulty is provided to the child at block 527. As is known in the art, depending on the application, the examination at block 527 may include multiple choice or true/false questions; short, written answers; essays; mathematical or scientific problems requiring a solution; standardized tests; as well as graphical or multi-media responses. Other types of examinations as known in the art can also be included. A timer arrangement as discussed above for the display component of the presentation may also be used, as understood by persons skilled in the art, in the examination portion, so that when a response is not received from the child within a certain length of time, the system saves the child's examination context and exits. Upon the completion of the examination, then, at block 528, the examination is scored and results are reported to the child. Then, the number of points accumulated by the child is updated in the database at block 529, and control returns to block 404 of FIG. 4.

In one preferred embodiment, the central computer downloads presentation material to the user's local computer. The presentation material is then presented to the child from the child's local computer, without requiring interaction with the central system. This downloading of material takes place after the saved context has been retrieved, as indicated by 540. Since interaction with the central computer is not required, the communications link to the user's computer may be temporarily disconnected at this point. At a timeout, the user's computer transmits the presentation context to the central system computer for storage there in the system database, and the downloaded presentation material is deleted from the user's computer. To do this, the child's communication link with the central computer is re-established at this point and communication with the child proceeds from there. If no timeout occurs and, instead, the presentation completes, i.e., after the score has been established in block 528, the downloaded presentation material is deleted from the user's computer, which then re-establishes communication with the central computer and transmits the score there. Since the number of points earned during the presentation is temporarily stored in the user's local computer, this data is preferably encrypted—and decrypted at the central server—to prevent tampering by the user.

The technique described above of downloading educational material to the user's computer for local interaction is only one way of providing the child with the presentation. Based on this disclosure, a person skilled in the art may provide educational material or another content in other ways. In another preferred embodiment, instead of downloading the presentation to the user's computer, the interaction can proceed continuously with the central system computer over the network, the user's local computer functioning merely as an intelligent terminal. Intermediate situations, i.e., where the interaction proceeds directly with the central server, but, over the course of the presentation, various pieces are downloaded and executed locally, also may be used in yet another preferred embodiment. In the case that all interaction proceeds continuously with the central computer, the user's computer need not store earned points since examinations are scored centrally at the central computer. Also, as noted, content may be available at the user's computer, in which case the central computer transfers control to the local computer's software and on completion receives the earned points. As understood by a person skilled in the art based on this disclosure, known web site and browser technology can be employed for the preferred interaction with content (e.g., educational materials).

If a particular presentation is to be made by an authorized third party content provider, the sequence of steps that are carried out to provide the child with the presentation is as follows, as shown in blocks 510-513. The central system computer sends a message to the user's computer identifying the electronic address (e.g., Internet address, or URL) of the third party provider's presentation. The user's computer connects to the third party provider and participates in the educational presentation by: interacting directly with the third party; downloading software from the third party; or an intermediate situation as discussed above. On completion of the presentation, the number of earned points is transmitted from the user's computer to the central computer, or directly from the third party's computer to the central system computer, or from the third party's computer to the user's computer, which then transmits it to the central system computer. The route of transmittal depends on the chosen application. The central system computer should validate the third party's activities to ensure, for example, that the provider does not award an excessive number of points.

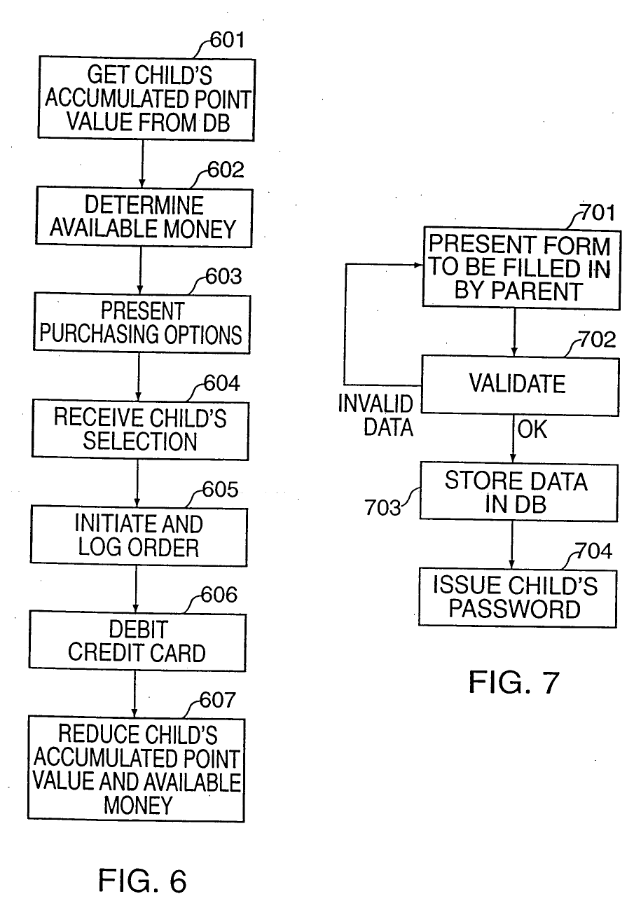

FIG. 6 shows the purchase subsystem. Beginning at block 601, the system retrieves the child's accumulated point total. Control then proceeds to block 602, where the system retrieves the monetary amount available to the child at that time. For example, a parent may specify that his child may spend up to $15 each month, and if no purchases are made over a two month period, then $30 is available, but at no time is more than $30 ever to be available to the child. Control passes to block 603, where the system presents the child with a menu of purchasing choices consistent with the child's accumulated point total and available purchasing power, as determined in blocks 601 and 602. In addition,.items on the menu are consistent with any specified parental preferences. For example, the parent may have indicated that toys of a violent nature are to be precluded. The purchasing choices can also be presented using an on-line virtual shopping mall, as known in the art.

At block 604, the system receives the child's selection(s), and at block 605 initiates and logs the order. Orders can be communicated to suppliers of goods and/or services by e-mail, postal mail, voice telephone, or any other means known in the art, and in the preferred embodiment must specify the item(s) that are ordered along with any required features (size, color, model number, catalog number, etc.), the child's name, and the child's address. As understood by a person skilled in the art, the items to be purchased may be ordered from on-line catalogs maintained by third parties. Also, depending on the choice, coupons for store credit or entertainment events, for example, can be printed at the user's computer. In some situations, electronic goods can be downloaded to the child's computer (a computer game, for example.). At block 606, the parent's credit card account is debited by the appropriated amount, based on the selected item(s). Alternatively, the credit card may be credited regularly on a periodic basis (e.g. monthly). In this case, the purchase total would be deducted from the total accumulated monetary amount, which is stored in the system's database. Finally, at block 607 the child's accumulated point total is reduced by an amount consistent with the child's purchase, and control returns to the child dialogues high-level menu, block 401 of FIG. 4. As understood by a person skilled in the art, the vendors including third party catalog companies may pay commissions to the present service in connection with the goods and services purchased through the service.

FIG. 7 shows the new child account dialogue, which allows a parent to open a new account for a child. Control is passed here from block 303 of FIG. 3. Starting, then, at block 701, the system provides the parent with a screen form, requesting that the parent fill in the form and provide the system with information necessary to open a new account. The information includes, for example, the child's name, address, sex, age, and inclinations; parental preferences regarding presentations, advertising, educational institution interaction and purchasing; and payment information, e.g., credit card number and allowable monthly spending limit. At block 702, the system validates the payment information by contacting, electronically, a credit card company or another source consistent with the form of payment and, if approved, stores the entered data in the system database at block 703. At block 704, the system issues a password for the newly created child account, which is presented to the parent. The child has the capability of changing the password subsequently.

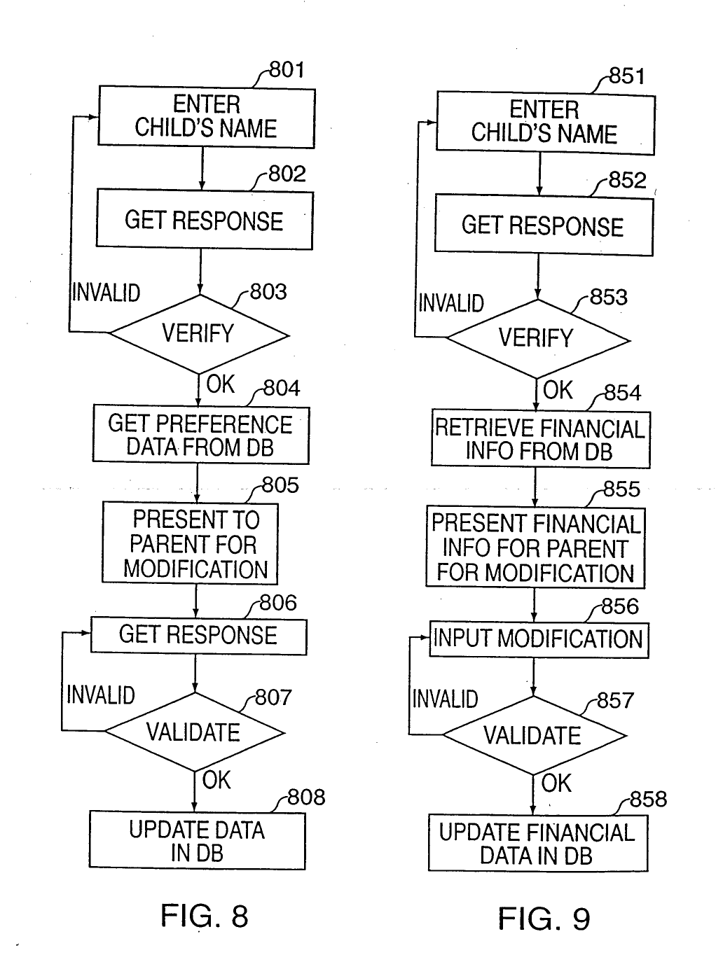

FIG. 8 depicts the parental preferences dialogue subsystem of the preferred embodiment (see block 304). At block 801, the system of the preferred embodiment generates a prompt requesting input of a child's name, and at block 802 the system reads the entered data representing the name. Then, at block 803 a database query is made, and if the child's name is found associated with the parent, control proceeds to block 804; otherwise, an error message is displayed and control returns to block 801. Alternatively, at block 801 the system may automatically retrieve all the children names associated with the parent and present an appropriate menu selection, thereby bypassing blocks 802 and 803.

Based on the specified child's name, parental preference data for the specified child is retrieved from the database (block 101 of FIG. 1) at block 804, and appropriately displayed to the parent at block 805. As discussed previously, illustratively, the preferences include: type and level of difficulty of educational material, preferences regarding advertising, and preferences regarding goods and services that can be purchased by the child. Specific preferences depend on the specific implementation and trade-offs associated therewith. At block 806, the user interactively changes the preference data, if desired, by specifying new parameters and, if the new data is valid and consistent, at block 808 it is then stored in the system database. If the system finds an error in the entered data, the system issues an appropriate message to the parent and control returns to block 806.

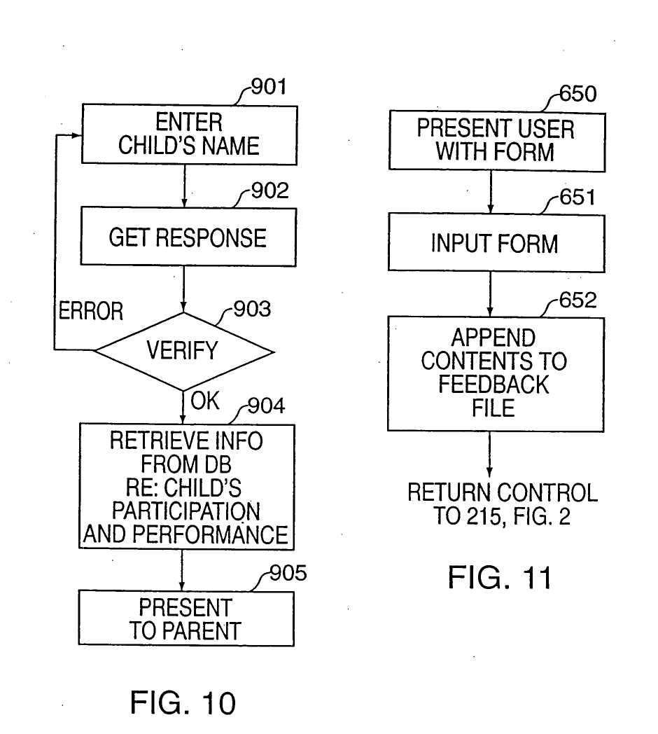

FIG. 9 depicts the preferred modify child's account dialogue (see block 305). At block 851, the system of the preferred embodiment generates a prompt requesting input of a child's name, and at block 852 the system inputs the entered name. At block 853, a database query is made to validate that the child's name is indeed associated with the parent, and, if the entered name is valid, control proceeds to block 854; otherwise, an error message is displayed to the parent and control returns to block 851. Alternatively, at block 851 the system may automatically retrieve all the children's names associated with the parent and present an appropriate menu selection, thereby bypassing blocks 852 and 853. Then, at block 854 financial information is retrieved from the system database and displayed appropriately at block 855. This information includes the form of payment and the spending limit imposed on the given child. The system inputs the parent's modifications to the data at block 856, and validates them at block 857. The validation step may include contacting a financial institution, electronically or through an operator, if limits are changed significantly or if a payment mechanism has been changed, e.g., a new credit card number is entered. Optionally, validation can include fraud detection verification that tests for significant or unusually frequent fluctuations in payment limits. Once the new financial data has been validated, it is stored in the system database at 858.

FIG. 10 depicts the preferred monitor child's performance dialogue. At block 901, the preferred system generates a prompt requesting input of a child's name, and at block 902 the system inputs the name entered by the parent. Then, at block 903 the system executes a database query and, if the child's name is indeed found to be associated with the parent, control proceeds to block 904; otherwise an error message is displayed and control returns to block 901. Alternatively, at block 901 the system may automatically retrieve all the children's names associated with the parent and present an appropriate menu selection, thereby bypassing blocks 902 and 903. At block 904 the system determines and appropriately displays (block 905) to the parent information regarding his child's participation and performance, including the total number of points accumulated by the child, the child's purchase history, and the history of educational presentations participated in by the child. Also the information about which schools the child has applied to or which schools he/she has considered using the services of the educational institution interaction subsystem may be provided to the parent.

Preferably, the information is stored in the system database in a separate child log table associated with each child. Each event concerning a child, e.g., participation in a particular educational presentation or a purchase, is recorded in the child's log table by the system. It is retrieved with an appropriate query expressed in a query language, such as SQL, supported by the database management system (block 102 of FIG. 1). In other embodiments, other techniques know in the art may be used; for example, a separate log file may be associated with each child, or a single log file or table recording events associated with all users of the system may be used. (Log files need not be under the control of the database management system—block 102 of FIG. 1—but instead can be managed using the file system capabilities provided by the native Operating System.) FIG. 11 depicts the feedback manager 107, which is used by users to send suggestions, complaints, and/or comments to the system administrators and management. In the preferred embodiment, feedback messages are stored in a separate disk file. The feedback file is not controlled by the database management system (block 102 of FIG. 1) in the preferred embodiment, but in other embodiments it may indeed be. In the preferred embodiment, feedback messages are appended in a sequential fashion to the end of the feedback file as they are received from users one at a time.

At block 650 of FIG. 11, then, the user wishing to send a feedback message is given a screen form to complete. Preferably, the form has fields for comments, suggestions, and/or complaints, in addition to other optional fields that may appear, such as the name of an educational presentation or educational institution to which the comment/suggestion/complaint applies. Also school administrators participating in the services of the educational institution subsystem can use the feedback manager using an appropriate form associated with their participation in the service as further discussed below.

At block 651 the completed form is input by the system, and at block 652 its contents are appended to the feedback file, as discussed above. The administrative subsystem (block 103 of FIG. 1) should include software procedures by which system administrators and managers retrieve, read, delete, and generally manage the feedback messages stored in the feedback file. Software procedures for managing a sequential file, such as the feedback file in the preferred embodiment, are known in the art. On completion, control returns to block 215 of FIG. 2.

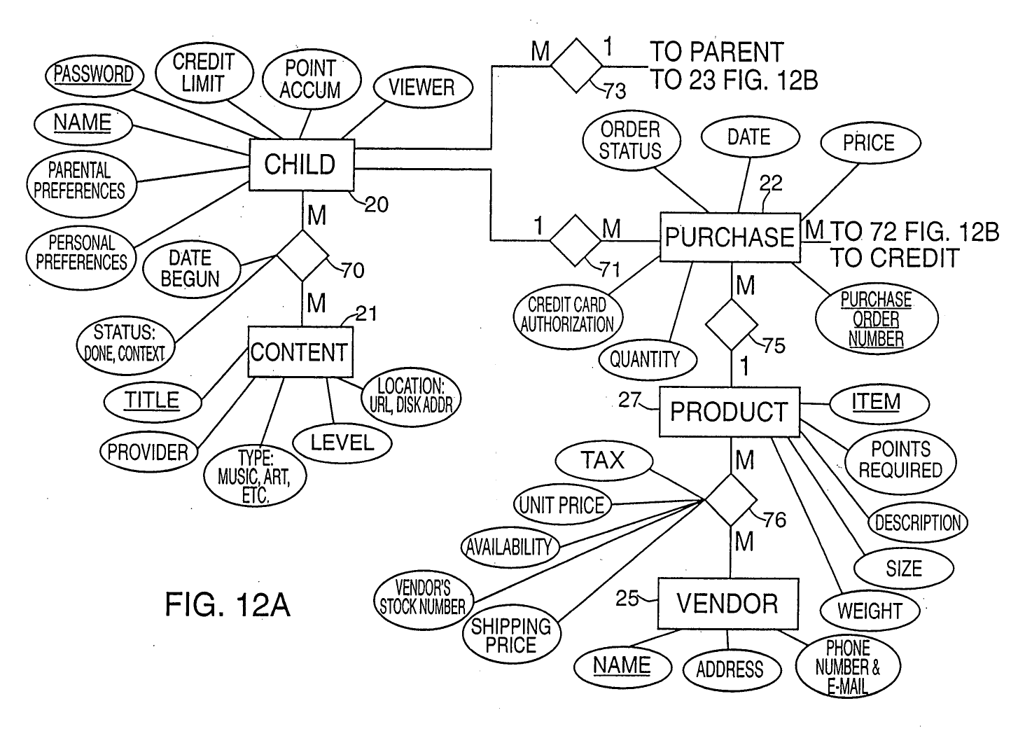

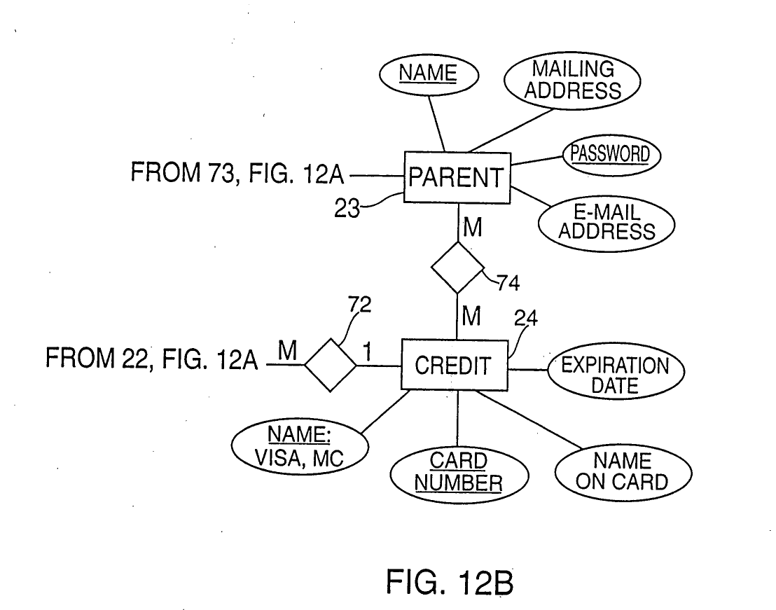

FIGS. 12A and 12B provides an illustration of the organization of the system database (block 101 of FIG. 1). Other disk files, not included in the system database pictured here, are also employed in the preferred embodiment. In various embodiments, these disk files may or may not be under the control of the database management system (block 102 of FIG. 1). Preferably, these disk files are created, maintained, and accessed through file system capabilities provided by the native Operating System, as is known in the art, and not through the database management system. As is known in the art, using disk files for certain purposes can be more efficient than using elaborate database management system software. In the preferred embodiment, these separate disk files are used to store such things as user feedback messages, as described above in conjunction with FIG. 11, and to maintain a log of system activities to be accumulated over time for the purposes of collecting historical data. (Historical data is used by system administrators and managers to performance tune the system—block 103 of FIG. 1—and for other purposes as they deem fit.) Other embodiments may choose to avoid altogether the use of disk files that are not under the auspices of the database management system. In such embodiments, such things as feedback messages and historical log files are managed by the database management system.

The system database (block 101 of FIG. 1) is modeled using an Entity-Relationship (E-R) diagram, as is commonly done in the art to describe a database. The Entity-Relationship modeling technique is described in the text by A. Silberschatz, H. Korth, and S. Sudarshan entitled Database System Concepts, Third Edition, McGraw-Hill Companies, Incorporated, New York, 1997, pp.23-62, and in the text by R. Elmasri and S. Navathe entitled Fundamentals of Database Systems, Second Edition, Addison-Wesley Publishing Company, Menlo Park, Calif., 1994, pp. 39-68. (The cited texts are included herein by reference.) As is known, the database represents and physically stores information, which in the system of the preferred embodiment is stored physically using appropriate, e.g., magnetic, electronic, and/or optical, media. In the preferred embodiment, the database is organized as a relational database, which are generally described in the above mentioned text by Elmasri and Navathe, pp. 137-286; in other embodiments, other data organizational models, such as network or hierarchical, may be used. Network and hierarchical data models are described in the above mentioned text by Elmasri and Navathe, pp. 287-390. The items of information contained in the database and the relationships among them are depicted using conventional representation employed for databases, wherein rectangles denote entity sets, ellipses denote attributes, primary-key attributes being underlined, and diamonds denote relationship sets. As known, attributes can be associated with relationship sets as well as with entity sets, in which case they are termed “descriptive attributes.” Also, as conventionally known, the indications “1” and “M” illustrate the nature of the relationship set, i.e., one-to-many, many-to-one, many-to-many, or one-to-one.

Based on the database model shown in FIGS. 12A and 12B, a person skilled in the art will be able to construct a database for a specific implementation by appropriately manipulating the information using known techniques, such as are described in the above mentioned text by Silberschatz, Korth, and Sudarshan. The database model depicted in FIGS. 12A and 12B include the following entity sets: child entity set 20, content entity set 21, purchase entity set 22, product entity set 27, vendor entity set 25, parent entity set 23, and credit entity set 24. The child entity set has a many-to-many relationship set 70 to the content entity set, and a one-to-many relationship set 71 to the purchase entity set. The parent has a one-to-many relationship set 73 to the child entity set, and a many-to-many relationship set 74 to the credit entity set. The credit entity set has a one-to-many relationship set 72 to the purchase entity set. The product entity set has a one-to-many relationship set 75 to the purchase entity set, and a many-to-many relationship set 76 to the vendor entity set.

In the illustrative embodiment, entity set attributes are defined to include, but are not limited to, the following, as shown in FIGS. 12A and 12B. Child entity set 20 attributes include name, password, credit limit, point accumulation, viewer, parental preferences, and personal preferences. Attributes name and password form the primary key. Content entity set 21 attributes include title, provider, type, level, and location. Attribute title forms the primary key. Purchase entity set 22 attributes include purchase order number, quantity, credit card authorization number, order status, date, and price. Attribute purchase order number forms the primary key. Product entity set 27 attributes include item, points required, description, size, and weight. Attribute item forms the primary key. Vendor entity set 25 attributes include name, address, and phone number. Attribute name forms the primary key. Parent entity set 23 attributes include name, password, mailing address, phone number, and e-mail address. Attributes name and password form the primary key. Credit entity set 24 attributes include name, card number, expiration date, and name on card. Attributes name and card number form the primary key.

In the illustrative embodiment, relationship set attributes (termed “descriptive”attributes in the art—see above mentioned text by Silberschatz, Korth, and Sudarshan, p. 28) are defined to include, but are not limited to, the following, as shown in FIGS. 12A and 12B. Relationship set 70 includes attributes status, and date begun. Relationship set 76 includes attributes vendor's stock number, availability, unit price, tax, and shipping price. In other embodiments, other relationship sets may possess descriptive attributes as well. As noted, the database of the preferred embodiment provides physical computer storage for related data.

Although FIGS. 12A and 12B do not illustrate the database organization supporting the educational institution interaction, described in further detail subsequently, a person skilled in the art based on this disclosure, will be able to implement this portion of the database. Preferably, the educational-institution-related portion of the database is configured using known relational database techniques, see, e.g., the above-mentioned texts and related discussion.

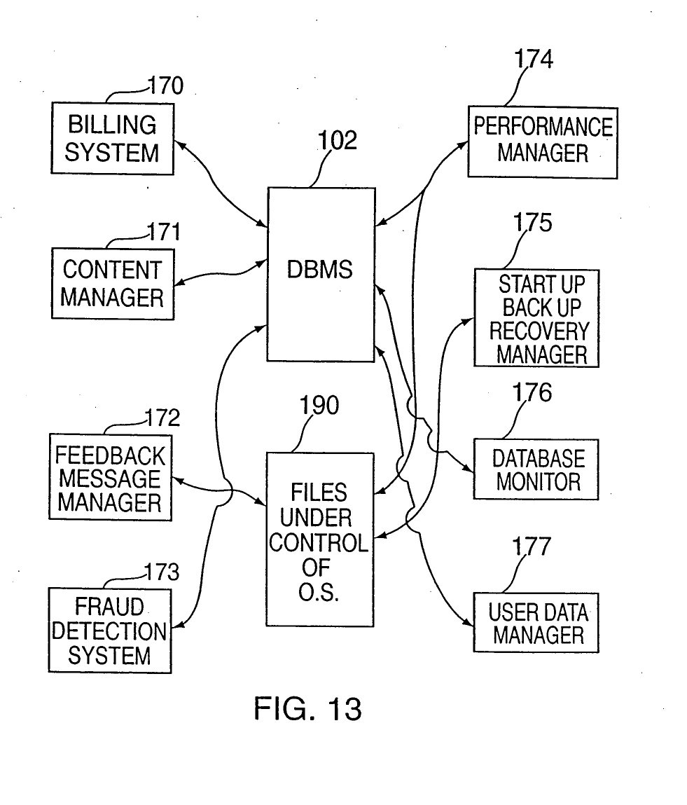

FIG. 13 shows the overall architecture of the administrative subsystem, which also appears as block 103 of FIG. 1. It is used by the system administrator(s) and management for monitoring performance; fraud detection; performance tuning adjustments; adding, deleting, and modifying educational and cultural materials and presentations as well as educational-instituton-related information; modifying user data in the system database; billing; and system backup and recovery. As illustrated, blocks 170, 171, 173, 174, 176, and 177 shown in the figure interface and makes use of the database management system (block 102 of FIG. 1). Some, such as blocks 172, 174, and 175 in the preferred embodiment, interface and make use of general computer in facilities provided by the native Operating System illustrated as 190. In the preferred embodiment, blocks 170-177 are software modules composed of software procedures and program data that perform indicated tasks.

Block 170 is the billing system, which is the software responsible for billing users and other parties for monies owed. It is composed of software components known in the art. Block 171 is the educational content manager, which is a software module responsible for inserting, modifying, and deleting content into/from the system. Block 172 is the feedback message manager, which retrieves, presents, and deletes feedback messages from the feedback file, as described above in conjunction with FIG. 11. Block 173 is the fraud detection system, which is a software module responsible for monitoring user behavior in real-time and detecting unusual system usage patterns and purchases. When it detects events that signal possible fraudulent behavior, it prints appropriate messages on an administrator's computer screen and/or disables user accounts in the system database. Block 174 is the performance manager, which supports the real-time monitoring and tuning of system resources. It provides performance statistics on computer screens manned by human administrators, and logs system behavior in appropriate log files for later recall, analysis, and study. In addition, it monitors the internal state of the system for situations that might require drastic intervention, e.g., very high CPU usage, very low free disk space, and long user response times. The performance manager provides human administrators with capabilities to tune system parameters for optimal system behavior. Block 175 is the startup, backup, and recovery manager. It is a software module responsible for starting up the system when it is down, periodically backing up the database and main memory of the computer(s), and recovering from hardware/software failures. Block 176 is a software module that provides administrators with the general capability to query, modify, and delete all information in the system database not directly connected to users and their accounts, e.g., vendor data. Block 177 is a software module that provides administrators with the specific capability of querying, modifying, and deleting information in the system database connected specifically with users and their accounts, e.g., user passwords.

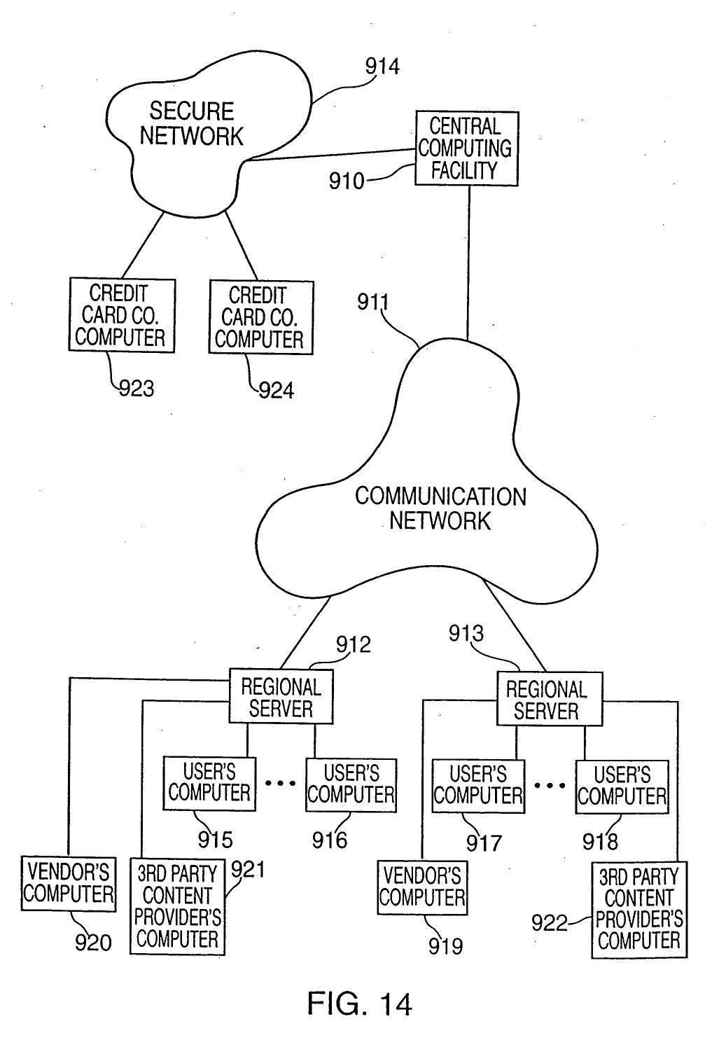

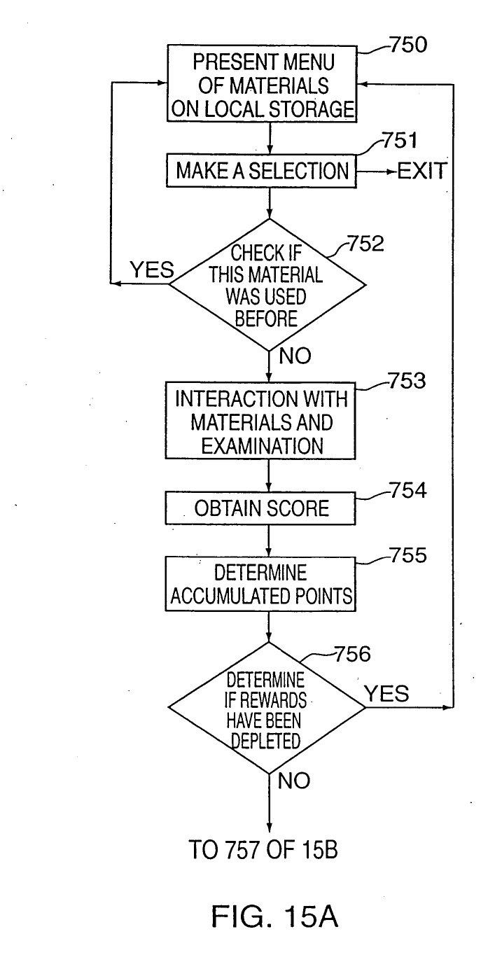

FIG. 14 depicts the communication network of the present invention in the preferred embodiment. Other embodiments may find it appropriate to deviate from what is shown here based on appropriate economic, marketing, technological, legal, security, reliability, and/or performance factors. Persons skilled in the art are able to take factors, such as those mentioned here, into consideration when tailoring the present invention to a particular application.

Block 910 of FIG. 14 shows the central computing facility, which also appears, but with more detail, as FIG. 1. In the preferred embodiment, it is connected to a communication network, 911, which is preferably of a telecommunications type, as known in the art. Preferably, the system of this invention takes advantage of networking capabilities provided by Internet. As known in the art, a network that is not tied to the telephone system may also be used, such as a private or semi-private wide-area network. In some applications, wireless communications means, such as satellite or radio communications, can be used. In other applications, local-area networks may also be used. Network 911 depicts the communications backbone of the present invention. In addition to the central computing facility 910, other facilities may also be connected to the communications network 911. They include regional servers, two of which are shown as blocks 912 and 913, and also one or more secure networks for communicating with credit card companies, one of which is illustrated as 914. Such secure networks used for electronic communication with credit card companies are known in the art. Alternatively, the credit card companies, shown as 923 and 924, can be connected directly to the communications network 911 in some embodiments.

Regional servers 912 and 913 support local communication with local computers (915, 916, 917, and 918), vendors' computers (919 and 920), and/or third party content providers' computers (921 and 922). Though only two regional servers are shown for illustrative purposes, a person skilled in the art will appreciate that many such regional servers can be present in a particular application.

In the preferred embodiment, users' computers 915, 916, 917, and 918 are connected to regional servers 912 and 913 by telephone dialing through modems. Preferably, the telephone calls are local calls, or they can use available “800” number services as provided by one or more of the telephone companies. Such arrangements whereby users have a choice of making either a local call or an “800” call are known in the art. Other arrangements are also possible, such as dedicated communication lines (telephone or otherwise) between the users and regional servers 912 and 913. In some embodiments, communications services can be provided to the users by organizations other than the telephone companies, and in other embodiments wireless communications (satellite, optical, or radio, for example) can be used. Combinations of these methods can also appear, as is known in the art.

Vendors' computers 919 and 920 connect to regional servers 912 and 913, which may or may not themselves also be used to provide communications to users'computers 915, 916, 917, and 918. FIG. 14 illustratively shows servers 912 and 913 connected both to users' and vendors' computers, but that need not necessarily be the case. In some embodiments, some vendors may have their own servers. Similarly, third party content providers 921 and 922 connect to regional servers 912 and 913, or in some embodiments may have their own servers, or share servers with vendors.

Various embodiments can be implemented based on this disclosure. For example, a simplified version of the system, in which all parents pay the same set fee, can be implemented. Another possibility is for points to be financed by advertisers, who provide advertisement displayed in conjunction with educational content. The advertiser providing advertisement with particular materials finances points when that material is used and the user is exposed to the advertisement. In yet another alternative, it is not necessary for the parent to control content. Instead, based on the difficulty level of the content, different categories of points are awarded, that is, presentations for different ages (or different types of audiences) will award different categories of points, corresponding to the age category of the content. The products available for purchase are also categorized according to different categories of points, so that older children are not able to “cheat” by completing easy, lower-level exercises and thereby gain access to products that they want without completing an appropriately difficult educational presentation. More sophisticated products can be is purchased only with points in an advanced category. In another embodiment, vendors of products can give rebates, for example, to encourage purchasing of their products.

A person skilled in the art will appreciate that a variety of diverse applications may be built based on this description. For example, vendors of software products may use the disclosed system to give potential buyers an opportunity to preview and explore their products. If, for example, the products are computer games, then in such an embodiment the content would be versions of the game available for purchase. Users would play the games for a limited amount of time and accumulate some points. These points, up to the limit established by each vendor, will then be used to provide discounts to users who decide to purchase, in this example, a game available through the purchase subsystem (block 112 of FIG. 1). Thus, users benefit by experimenting with products and, at the same time, receive discounts; vendors increase user exposure to their products. In such an application, the vendors play the role of parent and potential customers play the role of children.

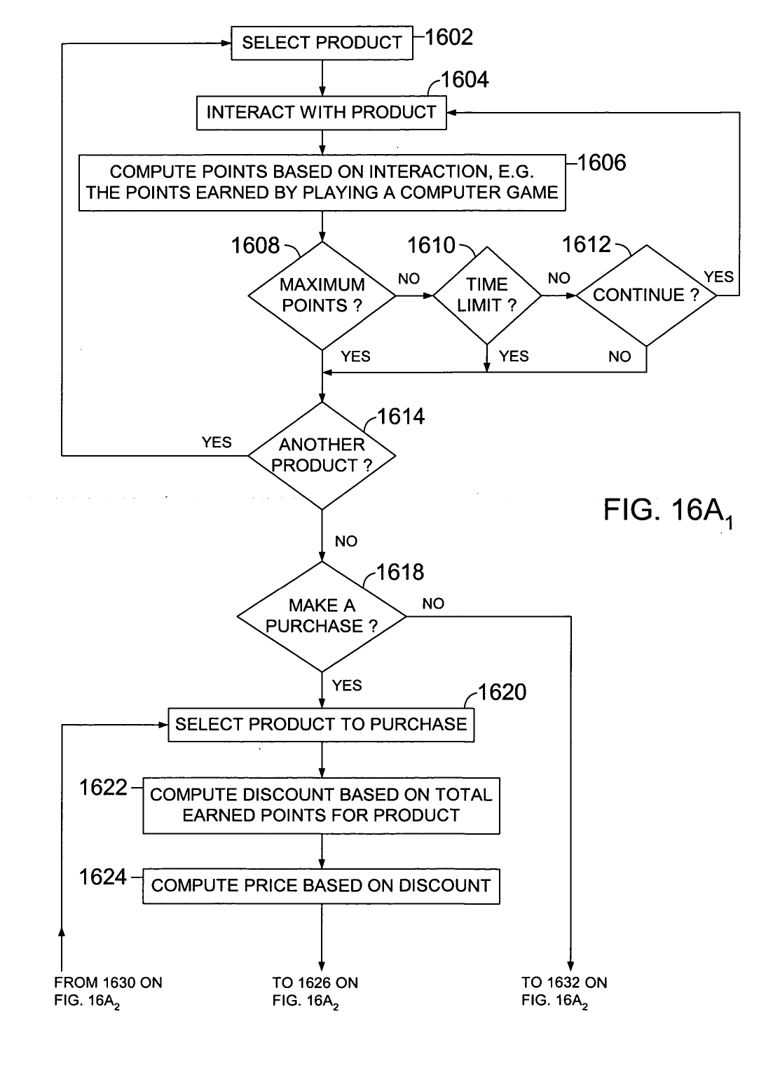

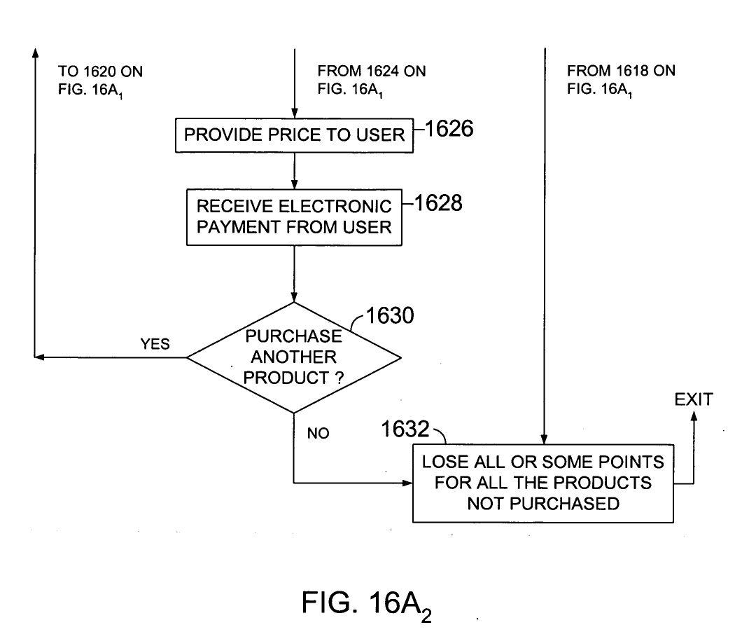

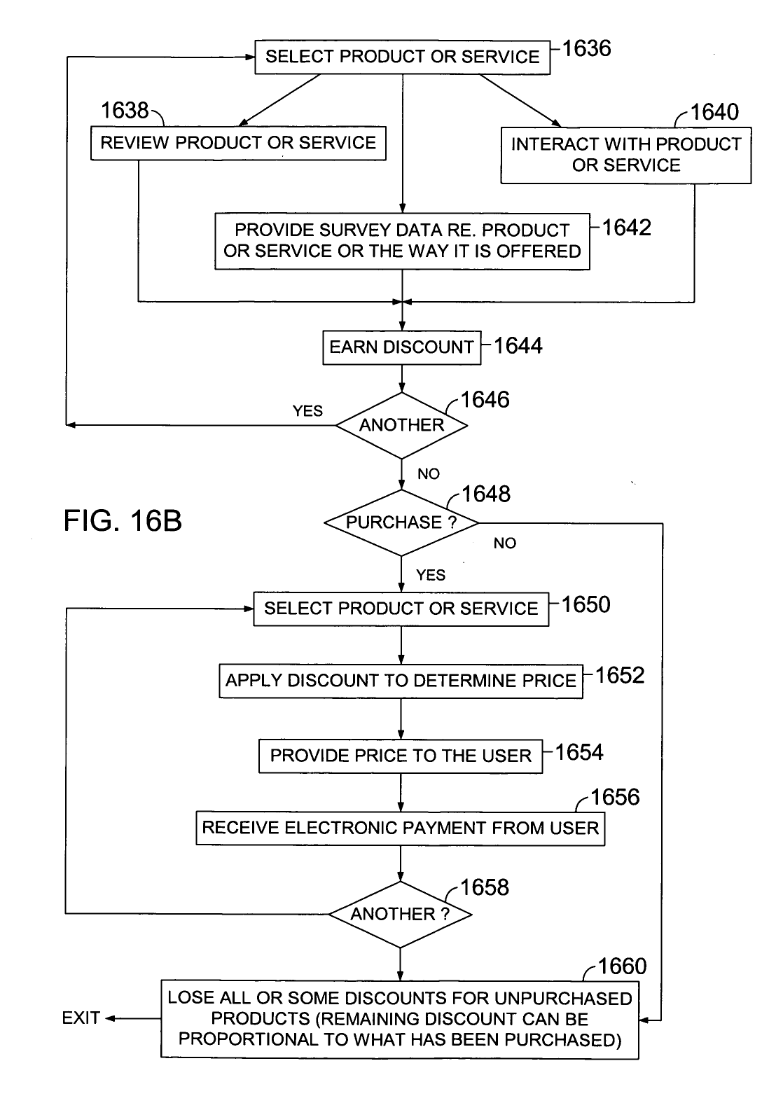

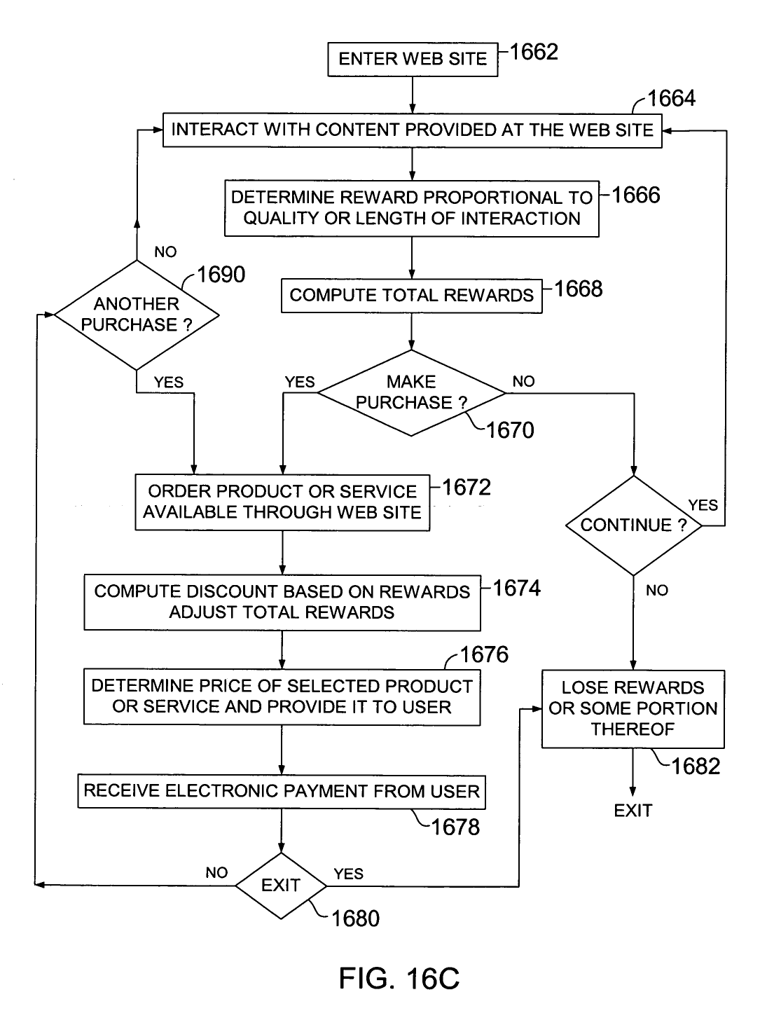

For example, application of the disclosed systems and methods to uses unrelated to education and cultural enrichment as discussed above is illustrated in FIG. 16A. First, a user enters an Internet Web site that includes an on-line shopping application, e.g., an on-line shopping catalog as known in the art. Based on this disclosure and as understood by a person skilled in the art, the central computing facility of the preferred embodiment can be configured to support such a shopping application. Various on-line shopping systems are well-known. In the example of FIG. 16A, the user can interact with samples of the offered interactive products. As discussed above, such products may include software applications, e.g., computer games.

At 1602 the user, e.g., a customer, interactively selects such a product and the system supporting the shopping application enables the customer to interact with a sample of the product, as known in the art. For example, it is known in the art how to play an on-line computer game free on a trial basis, e.g., up to a certain difficulty level or for a limited time, but to play further the user must purchase something, preferably, the product he/she is trying out. Of course such free trial periods are known for other software as well, not only for games. At 1604, the user interacts with the product, e.g., plays the game and at 1606, the system computes a measure of the user's interaction, which can be expressed in points, such as the points earned when playing a game. If a maximum number of points for earning a discount for the selected product has been specified, the central system checks for such a maximum at 1608, and at 1610 the system check if the maximum time allowed for the user to interact with the product on the trial basis has expired, if such a limit has been specified. If at least one of the answers is yes, the total number of points earned is stored in association with the user and the product, and the user can select another product for interaction. (See 1614.) Otherwise, the user can continue interacting with the same product. (See 1612.) Of course, the imposed limitations as discussed above can be: earning a maximum number of points, reaching a time limit, some other limitation or limitations, or some combination of these.

If the user does not want to continue interacting with products on this trial basis, he/she can purchase one or more of the products. (See 1618.) The user interactively selects the desired product at 1620 and at 1622 the central computer computes the discounts based on a measure of the previous interaction with the selected product, e.g., based on the points earned as a result of playing a game or time spent interacting with software. Next, at 1624 the price to the user is computed based on the discount by, for example, subtracting the discount from the listed price or using another formula, e.g., by taking into account other available discounts. The price is then displayed to the user (1626). If the user still wishes to purchase the product, he/she authorizes an appropriate payment method and, at 1628, the payment is made as known in the art, e.g., using a known credit card transaction. (The user-can also cancel before authorizing the payment, in which case control returns to 1618 without the purchase transaction completing.) Then, if another purchase is desired flow returns to 1620. (See 1630). Otherwise, the user exits this service. On exiting, discounts (e.g., points) earned in connection with the examined products that have not been purchased are withdrawn. (See 1632.) Alternatively, not all discounts (points) may be lost, but only a portion of the discounts (points). For example, if the user purchases many products at a given time, a portion of the discounts (e.g., points) could be retained until such time that the user reenters the site.

Of course, as understood by a person skilled in the art, the steps presented in FIG. 16A can be sequenced differently to accomplish the same overall function. For example, it is not necessary for the user to first experiment with products and then begin purchasing transactions only when the experiment period is complete. These processes can be interleaved so that the user can purchase a product at any time and then return to experimenting with other products, repeating these steps as many times as desired. Also, the discount and new price based on the discount need not be computed during the purchasing transaction, but can be computed and displayed to the user dynamically as he/she is experimenting with the product. In fact, fluctuating price for the product can be displayed to the user as the user interacts with the product. As noted, other variations can be employed as understood by a person skilled in the art. It is also possible to structure the discount as a rebate, which is paid to the user some time later.

Of course, this methodology may also be applicable to other shopping environments, as understood by a person skilled in the art based on this disclosure. As illustrated in FIG. 16B, a user interactively selects a product or service (1636), for example, on an Internet Web site. Then the user may review a product description available on-line (1638), e.g., through the Web site, and earn a discount on the product or service (1644). Similarly, a user can provide survey data (1642) regarding his/her experience with the product or service, or regarding his/her opinion about it and obtain a discount (1644) and/or credit towards the product or towards other products. The survey data entered at 1642 may also include feedback about the service offering the product or service. Also, at 1640 the user may interact with the product or service, for example he/she can interactively (i.e., electronically) “try on”clothing, as known in the art, and then receive a discount (1644). This process can be repeated (1646), or a user may decide to purchase one or more of the products or services that he/she has examined (1648). To purchase a product or service, the user selects the product or service at 1650 and then the system offering the product or service bases its price on the discount previously earned by the user in connection with the product or service. (See 1652.) The determined price is then displayed to the user (1654) and if the user still wants the selection, he/she provides a payment, as known in the art (1656). Other products/services can also be purchased at this point (1658). When the user elects to exit, the discounts for the products/services that were not purchased are withdrawn. Alternatively, as discussed above, some or all discounts may be retained, and the amount that is retained can be calculated to be proportional to the amount spent at a given visit to the site. See 1660. Also, as noted above, the particular sequence of steps can be altered, as understood by a person skilled in the art. For example, purchasing may be allowed to take place any time during the user's interaction with the shopping site rather than only after the user completes some initial activity.

FIG. 16C also illustrates a shopping application of the disclosed methodology. As understood by a person skilled in the art based on the above description, discounts received in connection with a given product should not necessarily be applicable only to the same product or service, but may be used for other products or services sold through the same site. Thus, in FIG. 16C a user enters, for example, a shopping Web site and at 1662 and at 1664 interacts with the available content, which may, for example, include as discussed above, experimenting with interactive products, reading about products, answering survey questions and the like. Then, at 1666 applicable rewards, e.g. discounts, are computed based on the measure of the interaction, for example, based on a score earned by playing a game, or the length of time a user spent reviewing a product description, or the time that the user spent at the site. The total reward is then computed at 1668. If a purchase is desired (1670), the user orders an available product or service at 1,672. In response, the system supporting the shopping site computes the discount based on the total accumulated reward. For example, there may be a maximum discount allowed for a particular product or service and, if the accumulated reward is greater than the maximum, only a portion of it is applied to the particular purchase. In this case, the total reward is adjusted to account for the reward applied to a given item. Then, the price of the ordered product or service is determined based on the discount and displayed to the user (1674). The user, in response, makes a payment, preferably electronically through a credit card (1678). Then, the user may make other purchases or continue interacting with the offerings and earn further rewards (1680). When the user elects to exit the site, he/she may lose the remaining discounts or a portion of the discounts. (1682) For example, the value of the discounts that the user retains after exiting can be proportional to the money spent at the site, so that little or no accumulated rewards are withdrawn if the user has made significantly large purchases.

As discussed, various preferred configurations and architectures may support the disclosed systems and methods and the choice depends on the trade-offs of a specific implementation, as understood by a person skilled in the art. Namely, as described above, software can be executed both at the central facility and at the user computer, the reason being to enhance performance given present hardware and communications constraints. It is also preferred that software primarily executes at central facility remote to the user, with the user computer running only a communication interface and Internet browser, that is, the present services may be accomplished as an Internet services, where the only software executing on the user's machine is a conventional Internet browser, such as those available from Microsoft®and Netscape®. An Internet TV appliance, where the user interacts, essentially, using a remote control for selection and response, can also be used.

In some implementations most of the functions can be performed in the local computers. Parental preference information would be stored at the local computer as well as the accumulated number of points earned by the child. The educational materials also would be provided locally, e.g. on CD-ROMs, and the results of the interaction would be stored locally. In such an implementation, central access can be simplified and used less frequently. It might be used, for example, only to make a purchase transaction.

In a further embodiment, all central interaction may be eliminated. In such an embodiment, educational materials are provided on disks, e.g. CD-ROMS, or as content downloaded from remote sources. All interaction with the user takes place locally. The local computer scores responses and provides awards as an electronic equivalent of cash, securely stored in the local computer, and subsequently usable for Internet shopping. When all the available awards have been provided the user, the user may continue using the materials without receiving rewards, or interaction with educational materials could be disabled.

Also, the fact that the system owes the user a particular reward can be stored on the same medium as the educational materials, e.g. on the same disk, in encrypted format. The reward would be redeemable by a user bringing the medium, e.g. disk, to a vendor, who, using decoding equipment, decodes the reward-related information, thereby enabling the user to receive his reward. In addition, the reward can be stored as money on a “smart card” or, for example, on a card provided by a transportation department authority, as a value redeemable for transportation rides. In a further stand-alone embodiment, the content can be recorded on a smart card and the rewards would be stored as money available through the use of the smart card.

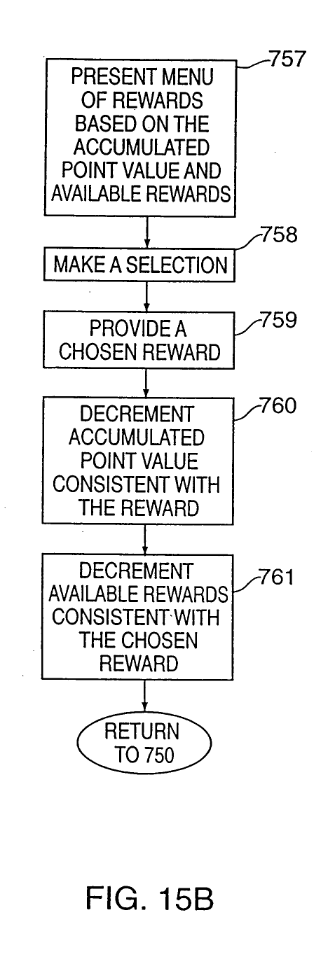

FIGS. 15A and 15B illustrate one alternative stand-alone embodiment, which is provided, for example, as a CD-ROM. A program on such a CD-ROM is executed exclusively on a user's local computer. At block 750, the menu of available materials is presented to the user. At block 751, the user makes a selection and at block 152 the system checks the hard drive of the local computer to determine whether the educational material has been already completed. If so, control returns to block 750. Otherwise, at block 753 the user is provided with the ability to interact with the educational material. (When awards are no longer available, the test at block 752 is skipped.)

At block 754, the score representing the results of the interaction is determined, and is then aggregated with the accumulated point value at block 755. At block 756, the system determines if further rewards are available, and if, all the rewards have been used, control returns to 750. In some embodiments, when all the rewards have been depleted, the program becomes disabled. If rewards are still available, at block 757 the menu of such rewards is presented. After a selection has been made at block 759, the user is provided with the chosen reward using an appropriate method as discussed above. Subsequently, at block 760 the point value and at block 761 the reward value are decreased consistent with the chosen reward. Finally, control returns to block 750, where the user is given an option to continue or to terminate the program.

It should be noted that this stand-alone embodiment is also applicable to uses outside of the field of education. For example, an interesting gift may be created through a collection of games accompanied by redeemable rewards earned as a result of playing the games. For example, a telephone company may distribute such disks as promotions, where the earned points are translated into certificates redeemable for telephone service. Also, smart-cards that combine content and monitory value related to content can be used as such gifts.

As discussed above, another application of the preferred embodiment is a system and method that assists a child in selecting a college or university and that assists colleges and universities in selecting appropriate applicants. The same technique is also applicable to selecting vocational schools, training programs, certificate programs, graduate and professional schools, academies, high schools, elementary schools, middle schools, and the like. Also, in other embodiments, as understood by a person skilled in the art, the techniques described herein can be used to find a job and by employers to find employees. In general, these techniques can be used to assist individuals in selecting an organization and by organizations in finding and selecting individuals. In addition, it can be extended to other applications as understood by a person skilled in the art. The service described herein can be financed by points earned as a result of the interaction with content (e.g., educational, cultural, or technical materials). Alternatively, this service can be paid for separately, e.g., by the parent charging an indicated amount through the payment access 108 as discussed above. It can also be sponsored by advertisers or by schools or employers or the like. It can also be sponsored by trade organizations, unions, institutions or public organizations, such as governmental or international agencies, the army, navy, and the like.

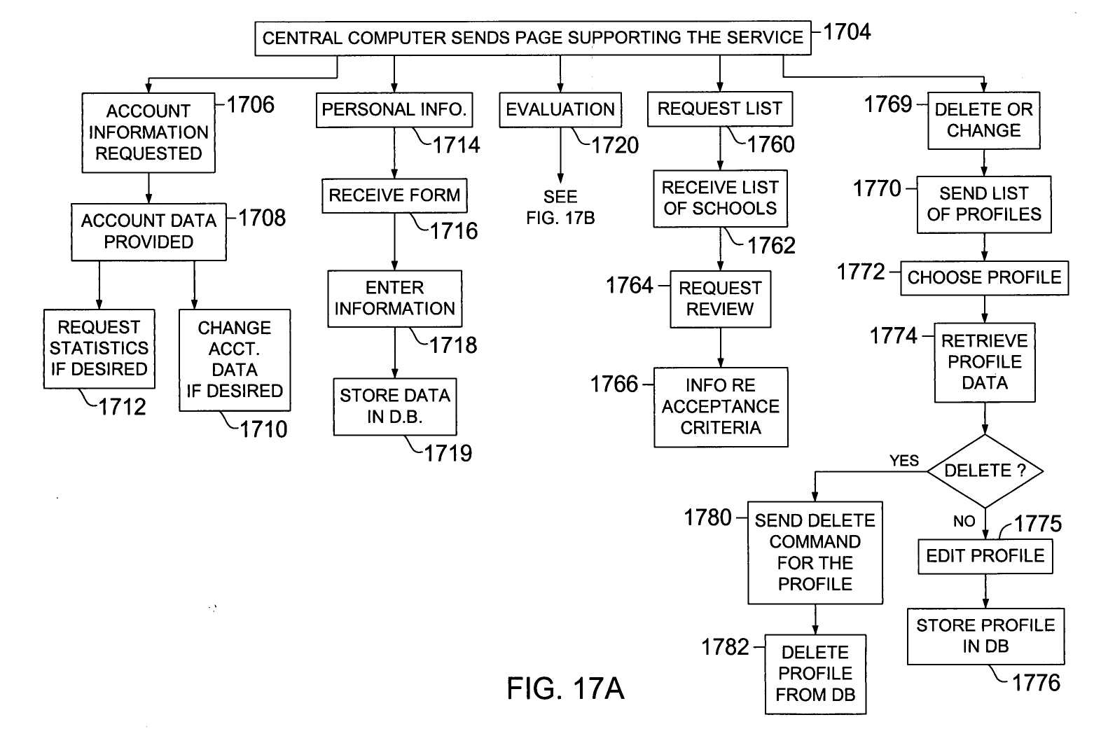

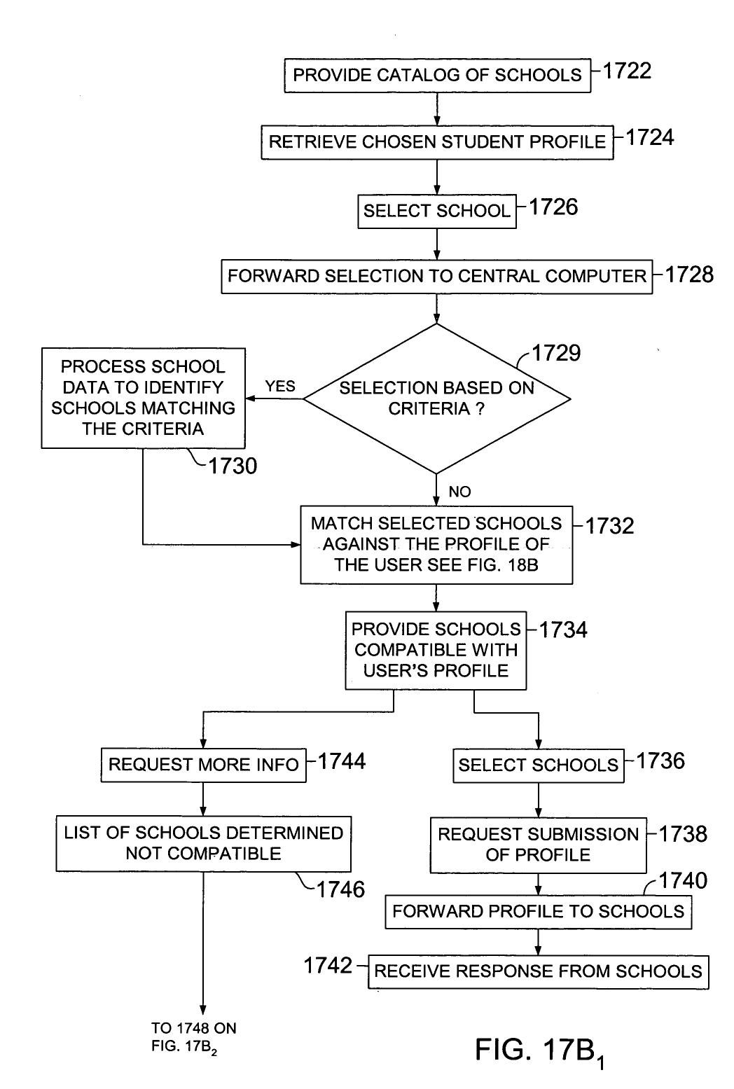

In FIG. 17A, the central computer sends an appropriate electronic service page supporting this service at 1704. At 1706 a user may request information about his/her account associated with school selection by making an appropriate selection from the main menu of the service. In response, at 1708 the central computer returns data indicating how much money or how many points remain in the school-related account. In addition, as part of this option, the central computer may provide to the local computer of the user other useful information, such as a listing of schools to which the student has submitted his/her profile. At this point, the user may also be notified of the schools that invite applicants to submit profiles. Subsequently, at 1710 the user may change the account data, for example, by entering a command that causes a transfer, electronic or otherwise, of money or points into the account. The user may also request statistics at 1712, which may include relevant statistical information and trends about schools or employment, as known in the art.

If, at 1714, a user selects an option to provide personal information by entering and transmitting an electronic command to the central computer, the central computer responds by returning an electronic form to the user's local computer (1716). If the user's data has already been stored in the database, the form contains information that has already been entered by the user. Otherwise, the user enters new information in the form. A given user may enter and store more than one profile. This can occur, for example, when a parent submits profiles for several children (say the parent has twin children in high school, for example), or when a child, for example, wishes to try out several profiles, each emphasizing different qualities (one emphasizing athletics, another emphasizing academics). User's name, address, and possibly other relevant data have already been provided and stored as discussed previously. At this point, the user can enter his/her information specific to the school selection process. (See 1718.) This information may include, among other items: the high school attended, classes taken and grades earned, SAT/GRE and other standardized exam scores, extra curricular activities, languages spoken, a scanned photo, a link to student's Internet Web site, honors and awards, letters of recommendation, and other relevant data. Other data can be entered in other embodiments, as understood by a person skilled in the art. This data is then stored in the data base in connection with the student at 1719. In an embodiment relating to employment, this data may include information typically appearing on a resume or curriculum vitae and multiple profiles can reflect multiple versions of the resume prepared for different positions or with different emphases.

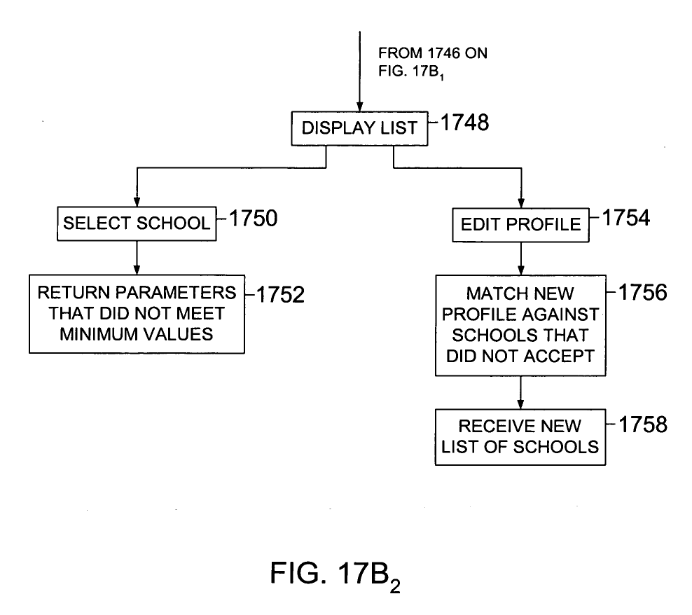

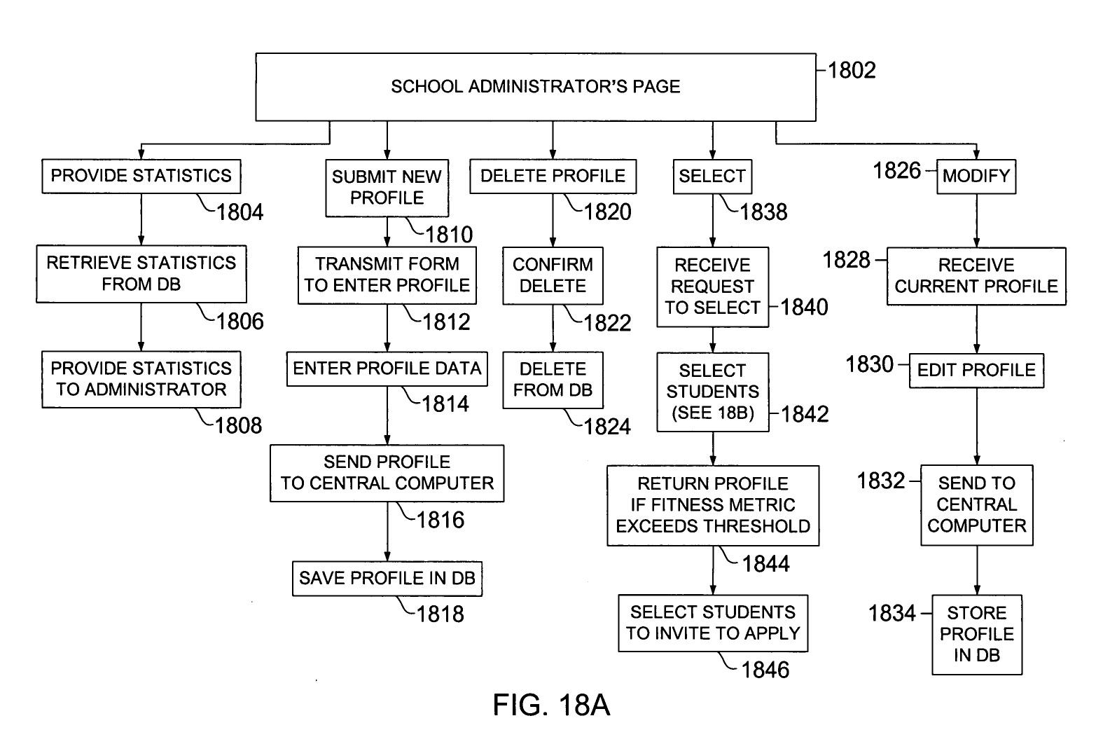

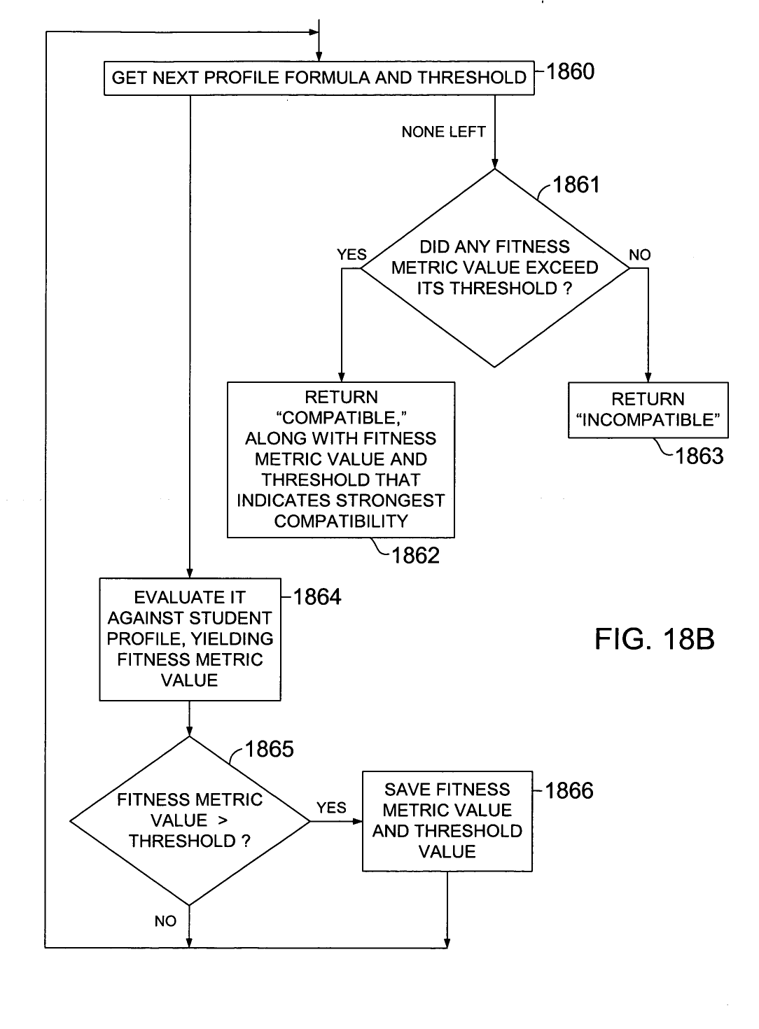

The evaluation option can be selected at 1720. The steps of the evaluation option are illustrated in further detail in connection with FIGS. 17B and 18B. The central computer provides to the user access to an electronic catalog of participating schools. (See 1722.) Also, the central computer retrieves the user's chosen profile from the database for evaluation. (See 1724.) The user then selects the schools in which he/she is interested (see 1726) and forwards this data to the central computer (1728). The selection can, for example, be made by entering a check mark next to the name of the school, or by any other technique known in the art for interactively making selections electronically. Also, schools may be selected based on their geographical location (e.g., all schools in a given state or within a certain radial distance) or by tuition (e.g., all schools that charge tuition less than a given amount), or by other criteria that can be ascertained from the stored school profile (e.g., average salary of graduates, percentage of graduates accepted in certain graduate and professional schools, available athletics, etc.). Multiple criteria can be specified by the user and combined using Boolean logical connectives (AND, OR, NOT) and logical functions (IF), as commonly found in formulas found in spreadsheet programs as is known in the art. If a selection is based on such criteria (see 1729), the system processes school data stored in the database or accessed on-line and selects the matching schools (see 1730).

After the selection of schools is, complete, profiles of the selected schools are individually matched against the profile of the user. (See 1732.) This procedure for determining the compatibility of a student profile with a school is illustrated in further detail in connection with FIG. 18B. It should be noted that the procedure shown in FIG. 18B shows evaluation of the student against a single school, and box 1732 of FIG. 17B indicates repeated invocation of that procedure, once for each school selected.

Preferably, a school maintains a collection of acceptance profile formulas (with an associated threshold for each formula), one for each category of students. For example, there might be a formula (and associated threshold) for academic students, where the weights are larger for grade point average and SAT score than athletic ability and leadership index, and a separate formula (and associated threshold) for athletic students, where the weights are lower for grade point average and SAT score and higher for athletic ability. Similarly, there might be a third formula (and associated threshold) for artistic students. A profile formula, as discussed further below, when executed results in an acceptance determination. It is evaluated against the student's profile, using the data found in the student's profile as values for the parameters of the profile formula. Evaluation of a profile formula yields a numerical value, normalized to the range 0-1, which is here termed the “fitness metric value.” (See box 1864 of FIG. 18B.) In alternative implementations, it can be normalized to the range 0-100, or any other suitable range of values. In other implementations it can even be un-normalized. Typically, the higher the value, the more compatible the student is with the school. The fitness metric value is compared against an associated threshold value, which is stored in the data base along with the profile formula as mentioned above. If a fitness metric value exceeds its associated threshold value, the school is marked “compatible.” If all fitness metric values for a school do not exceed their associated threshold values, the school is marked “incompatible.” In either case, the fitness metric values and associated threshold values can returned by the procedure for possible presentation to the user at his/her local computer.

FIG. 18B, then, details a procedure for determining if a student is compatible with a school. The central computer retrieves the next profile formula and threshold (1860) from the collection of formulas/thresholds stored in the data base and evaluates the formula against the student profile, yielding a fitness metric value. (See 1864.) If all formulas have been considered, control transfers instead to 1861 where a check is made to see if any formula yielded a value that exceeded its associated threshold. If not, then the procedure returns “incompatible” at 1863. If so, then the procedure returns “compatible” at 1862 along with the fitness metric value and associated threshold value that indicates the strongest compatibility with the school, i.e., the pair for which the value

$$\frac{fitness metric value}{threshold value}$$

is the largest. (In other embodiments, other measures of the strength of compatibility are also possible, as known in the art.) Returning to 1865, the fitness metric value is compared against its threshold value and if it exceeds it, the values are saved at 1866. If not, the procedure returns to 1860 for retrieval and evaluation of the next formula. Alternatively, the procedure could return all fitness metric values and associated thresholds, regardless of whether any resulted in a determination of “compatible.” At the conclusion of the process, the central computer provides to the user's computer over the network a list of schools that are compatible with the user's profile. Also, for each such school the fitness metric values and associated thresholds can be provided to the user and displayed. Optionally, the values

$$\frac{fitness metric value}{threshold value}$$

may also be computed and displayed to the user so that the user can see by what fraction he/she exceeds each threshold. (In other embodiments, other measures can be computed and displayed to the user, as known in the art.) Optionally, these fractional values can be converted and displayed as percent by multiplying them by 100. Optionally, only that fitness metric value and its threshold that indicates the strongest compatibility with the school is presented to the user, i.e., the fitness metric value and associated threshold value pair that resulted in the largest value for the fraction shown above.

Returning to FIG. 17B, at 1734, the user receives a list of schools compatible with the user's profile and the associated fitness metric values and thresholds. Thereafter (see 1736) the user may select the schools out of those that matched his/her profile, thereby indicating a high likelihood of acceptance, and instruct the system to forward the student's profile to those schools. (See 1738.) This submission of the profile can be, for example, for the purpose of applying for acceptance to the school, or for the purpose of applying for a scholarship or other financial assistance, or for a request that more information be sent to the student (such as an application packet, for example), or for other relevant purposes. In response, the central computer forwards, electronically or otherwise, the student's chosen profile to the indicated schools. (See 1740.) Subsequently, those schools that receive the profile may respond (electronically or otherwise) to the student by, for example, sending recommendations for courses to take for successful acceptance if the student is not yet at the level ready to apply to the school, or may forward an application, or offer a scholarship. (See 1742.)

In the embodiment related to seeking employment, as understood by a person skilled in the art, at step 1732, instead of identifying schools matching the profile, the system identifies employers whose requirements are met by the applicant's profile. At step 1736, the user selects such employers and at step 1738 instructs the system to forward the resume or curriculum vitae, which is stored with or as part of the user's profile, to employers. At 1742, the user may receive a request from an employer for further information, an invitation to schedule an interview, a message that the position has been canceled, or other responses.

As indicated at 1744, a user may obtain further insight into those schools that the system determined the user's profile was not compatible with. The user may electronically request a list of such schools. (See 1746.) In response to the request electronically provided to the central computer, the central computer provides a list of the schools for which the student did not meet the acceptance criteria. (See 1748.) The user can then select a specific school and request a list of those parameters that did not meet minimum values as set by the school, if the school has not blocked the release of such information. (See 1750.) In response, the central computer returns a list of those parameters that disqualified the student from the selected school. (See 1752.) Logical functions (IF) can be coded into the profile formulas to enforce minimum values for parameters. (These logical functions are described and illustrated below, in the discussion of how profile formulas are composed.) For each parameter and each profile formula, the system can indicate the differential between the student's value and the school's minimum requirement, if there is no indication in the data base that the school wishes to block release of such information.

Alternatively, the student may edit his/her profile by indicating those values that may possibly be improved, and indicating an amount of improvement in each of those values by, for example, showing a possible percentile or fractional adjustment in each. He/she may also indicate which values remain inflexible. (See 1754.) Then, this data is forwarded to the central computer, which reinvokes a procedure such as that shown in FIG. 18B described above against the profiles of the schools for which it was previously determined that the student's qualifications were insufficient. (See 1756.) (The procedure is reinvoked once for each school, as indicated above.) As result of this comparison, the new list of schools that would accept the student based on the new profile is displayed. (See 1758.)

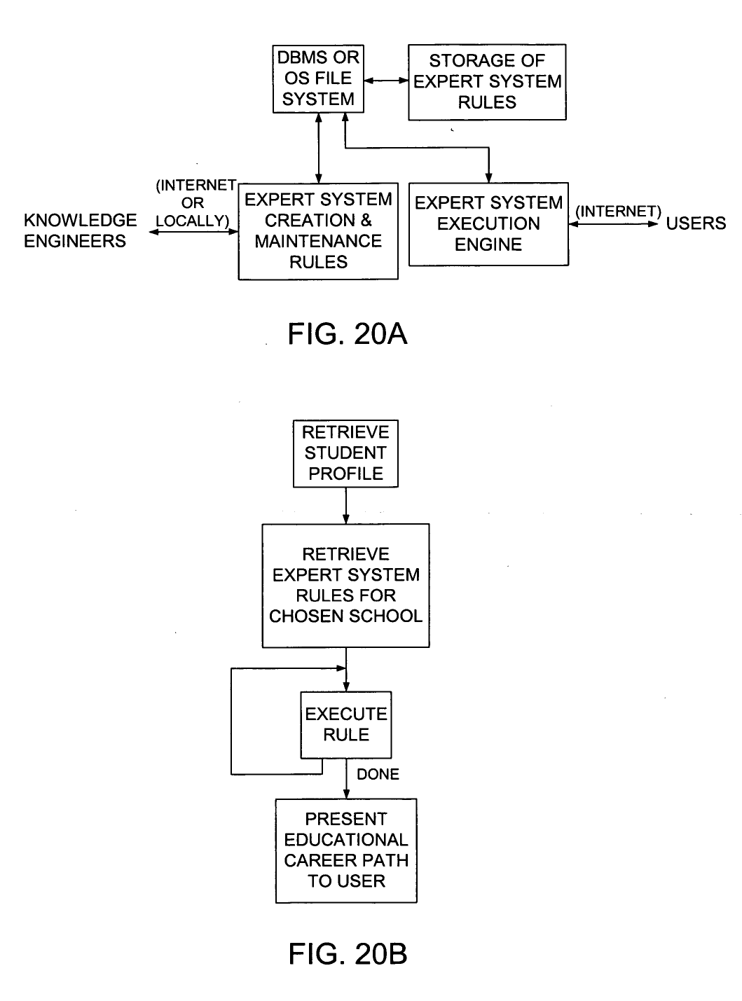

As illustrated in FIGS. 20A and 20B, the system can also allow a student who might not be ready yet to apply for admission to a particular school, because, for example, he/she is too young, the capability of planning his/her educational career so that eventually he/she will, with high likelihood, gain acceptance to the school. In the preferred embodiment, this is implemented as an expert system, using appropriate programming tools such as, for example, the PROLOG or LISP programming languages, as is well known to those who have ordinary skill in the art of knowledge engineering. Such an expert system, preferably consisting of rules that are executed if precedent conditions are met, is created by the knowledge engineer in consultation with experts in the field of school acceptance, namely, school administrators and others with expertise in this area. Techniques for creating a set of rules that encompasses the skilled knowledge possessed by experts in an area are well known in the art of knowledge engineering and artificial intelligence.

Preferably, stored in the data base associated with each school is the expert system for that school. If the student wishes to know what to do to eventually gain acceptance to a particular school, he/she will ask the system to invoke execution of the school's expert system through an appropriate menu pick or button selection. On invocation, the expert system will query the user for items of information, such as, for example, age, educational orientation (science, sports, arts, humanities, etc.), educational achievement of parents, income of parents, educational achievements of older siblings, etc. This will cause appropriate firings of rules in the expert system, causing more queries to perhaps be made by the system. This technique is well known in the art of expert systems, and possessed by those of ordinary skill in the art of knowledge engineering. It is described in the text by G. F. Luger and W. A. Stubblefield entitled Artificial Intelligence, Third Edition, Addison-Wesley Publishing Company, Reading, Mass., 1998, pp. 207-516, and in the text by F. Hayes-Roth, D. Waterman, and D. Lenat entitled Building Expert Systems, Addison-Wesley Publishing Company, Reading, Mass., 1984. (The cited texts are included herein by reference.) The expert system will present to the user's local computer a set of recommendations on how to plan his/her educational career to eventually gain acceptance to the school. The output to the user is advice similar or identical to what the human expert would provide to the student. Other implementations using artificial intelligence techniques other than expert systems are also possible and known in the art. Implementations of this feature of the system using techniques other than methods of artificial intelligence are also possible, and can include such things as storing the educational histories and profiles of students who were accepted for admission to the school in years past and retrieving them and perhaps comparing them to the user's profile and history and possibly presenting these histories to the users. Preferably, they would be presented anonymously, so that the user wouldn't be presented with personal data about known individuals.

Returning to FIG. 17A, the user can also browse a catalog of schools and review their acceptance criteria. In addition, there may be Web links to the school's Web sites so the student can learn more about the school and the programs it offers. The user sends the request for the list of schools at 1760 and receives the list of supported schools at 1762. Then the user may request review of acceptance criteria for any of the selected schools. (See 1764.) In response, the central computer provides this information to the user. (See 1766.) It should be noted that the user does not need to receive the entire listing of schools. The listing can be filtered based on a user-specified category as discussed above (e.g., geography, tuition, etc.)

The user may also delete or change his/her profile; see 1769. The central computer sends to the user the list of stored profiles submitted by the user. (See 1770.) Then, at step 1772, the user may choose a particular profile and in response the central computer electronically transmits to the student the data in this profile. (See 1774.) The user then can edit the electronic form representing the profile (1775) and electronically transmit it to the central computer, which in turn replaces the profile and saves the new one in the database. (See 1776.) The user may also delete the selected profile (see 1778), for example, by pushing a delete button or selecting delete from a pull down menu. Then, the delete command and the identification of the profile are provided to the central computer at 1780, which in turn deletes the profile from the database at 1782.

Although a typical college or university is composed of several educational units, e.g., law school, engineering school, medical school, liberal arts school, etc., each with it's own standards and entrance requirements, what is depicted here in this embodiment and called a “school” may well be only one of those educational units within the overall institution. Thus, a college's law school and medical school may register in the system as two separate “schools.” This may apply to other organizations as well, such as corporations and agencies, for example.

The school administration, in the preferred implementation, can also use the system. Each participating school is provided with an ID and password and can log into the central computer. After the school administrator has requested service and properly entered log-in information, the system transmits a service page (e.g, Web page) with a list of selections (1802), including: checking statistics, adding,-deleting, and modifying the school's profile, browsing students in the database, communicating with students, receiving documents on behalf of students, receiving payments, crediting points or money as discussed above to students' accounts.

If the option of providing statistics is selected at 1804, in response the system retrieves and/or computes statistics data from its database (1806) and transmits it at 1808 to the administrator. The statistics may include data such as how many students browsed this school, in which geographical locations (e.g., zip codes) these students reside, average grade point average or SAT/GRE score of students who browsed the site, and other information. These statistics are collected and computed from the students' interactions with the service and stored in the database (preferably organized using the relational model) in association with the students and schools. In another application of the preferred embodiment, e.g. employment, the statistics may include number of job seekers who browsed the employer, average number of years of education of those applicants who browsed the employer, and others.

If an administrator wishes to submit a new profile describing the school, at 1810 this option is selected and in response at 1812 the system transmits an electronic form for the school administrator to enter the profile information. At 1814, the school administrator enters the profile information and, at 1816, transmits the form to the central computer which saves it in the data base as illustrated at 1818. The profile may, for example, include the following information: data describing the school, such as location, number of students, faculty information, average grade point average of entering students, average starting salary of graduates, and other information. The profile also includes one or more profile formulas, each a computational formula that, when evaluated, yields a numerical value termed the fitness metric value and normalized to the range 0-1 (or 0-100, or other appropriate range) as discussed above in connection with FIG. 18B. A profile formula can be written using syntax such as is found in spreadsheet program formulas, as known in the art, and exemplified by products such as, for example, Microsoft's Excel™ or Lotus 1-2-3™. In the preferred embodiment, these formulas can include Boolean logical connectives (AND, OR, NOT) and logical functions (IF), as well as an array of statistical functions, AVERAGE, MEDIAN, for example, such as are found in spreadsheet programs. Other features found in typical spreadsheet programs, e.g., externally written functions coded in a general purpose programming language such as C or C++ and macros, may also be included. In addition to the profile formula, an associated threshold value is typically also supplied, as discussed above in connection with FIG. 18B. The formulas contain parameters, whose values are supplied at the time of evaluation by a student's profile data. A typical profile formula might be

0.4*normalized_{—}gpa+0.5*normalized_{—}SATscore+0.1*leadership_index

, where normalized_gpa, normalized_SATscore, and leadership_index are normalized parameters whose values come from the student's profile. Another typical formula, incorporating an IF function, might be

IF (gpa>3.8, 0.4, 0.3)*normalized_{—}gpa+0.5*normalized_{—}SATscore+IF (gpa>3.8, 0.1, 0.2)*leadership_index

, which gives greater weight to the student's leadership index if his/her grade point average does not exceed 3.8. (In other embodiments, profile formulas can include some or all features commonly found in more general purpose programming environments, such as, for example, loops, variables, macros, procedures, arrays, etc.) In the application relating to employment, the profile may include salary information, number of years of experience, education, and other data.

To delete a profile, the administrator selects this option at 1820, and in response the currently-stored profile is retrieved and forwarded to the administrator's computer. Then the administrator confirms the decision to delete at 1822, and if the decision has been confirmed, in response, the central computer deletes the profile from the database. (See 1824.) Also, the profile can be modified by the school administrator. In this case, in response to the administrator's request at 1826, the central computer transmits an electronic form at 1828 that includes the currently stored profile data. The administrator is provided with the capability of editing the profile (1830). After the edit has been complete, the profile is sent back to the central computer (1832), which stores the updated profile in the database. (See 1834.)

Furthermore, the administrator has the capability of browsing student profiles. At 1838, the administrator selects this option. The central computer receives the request at 1840 and, in response, executes a procedure such as that shown above in connection with FIG. 18B, once for each student in the data base. See 1842. (Alternatively, the administrator can select a subset of students found in the data base to evaluate for compatibility, e.g., those students living in a chosen geographical area, or those students attending selected high schools.) As a result, the central computer returns to the administrator those student profiles marked “compatible,” along with the fitness metric values and threshold values. (See 1844.) The administrator then selects the students that he/she wants to invite to apply to the school and enters a command to forward a list of students to the central computer. (See 1846.) The central computer in turn forwards an invitation to apply for school admission to the identified students. Alternatively, instead of selecting all students whose fitness metric value exceeds the threshold, the administrator may specify a subset of those students, for example, on the basis of the values of the fitness metrics and thresholds. As an example, the administrator may specify only the top 20% of students whose fitness metric value exceeds the threshold, or he/she may make a selection based on geography, or high level of achievement in a certain area, or based on other criteria. Relative measures of fitness, such as

$$\frac{fitness metric value}{threshold value}$$

, for example, may play a part, in that the administrator could choose those students with the largest relative measure of fitness. The central computer may save the results of the search computation, if so directed by the administrator, for later retrieval by the administrator. It should be noted that a student can indicate to the service that he/she wishes to block incoming solicitations from some or all schools. In this case, such a student who has been selected for invitation to apply would not receive an invitation.

Although not shown in FIG. 18A, the administrator is also provided with the capability of communicating electronically, as known in the art, with the students who elected not to block such communication. The administrator can also request and receive, electronically, documents on behalf of students, if appropriately authorized, from appropriate authorities, such as schools and standardized test agencies. The transactions concerning such official documents may employ cryptographic authentication and certification techniques as known in the art. Also not shown are payment transactions: schools can receive payment in connection with applications in the form of traditional credit card payment and/or using points earned by students as discussed above. Alternatively, a school may give students points, for example, to provide an incentive for exceptional students to apply to that school. Also, schools may essentially act as a parent and reward students for completing certain educational exercises, for example, to make sure that entering students are sufficiently prepared. In addition, a school may provide an incentive for a student to complete specific exercises that the school may find useful in determining whether the student should be accepted.

An additional or alternate way for a school to select candidates is through the setting of a logical “trigger,” whereby a student profile that is compatible with one or more of the college's acceptance profile formulas is automatically sent by the system to the college, using email for example, at the time the student profile is submitted to the system, unless the student has blocked that feature if he/she does not want the profile sent automatically. This is similar, for example, to the way certain Internet based dating and matchmaking services operate, and is well known in the art.

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims. Doubtless numerous other embodiments can be conceived that would not depart from the teaching of the present invention whose scope is defined by the following claims.

We claim:

1. A computer-implemented method comprising:
electronically enabling a user to access a selection of items of content over the Internet;
electronically enabling the user to choose a specific item of content-from the items of content available in the selection of the items of content;
electronically enabling the user to access the specific item of content;
electronically enabling the user to interact with the specific item of content;
electronically determining a monetary value of the user interaction with the specific item of content;
electronically enabling the user to access over the internet a selection of at least one of products and services;
electronically enabling the user to choose a specific product or service available in the selection of the at least one of products and services;
electronically enabling the user to purchase the specific product or service; and
electronically applying at least a portion of the monetary value of the user interaction with the specific item of content towards the purchase of the specific product or service available in the selection of the at least one of products and services:

2. The method of claim 1 wherein the items of content comprise at least one of educational and cultural materials.

3. The method of claim 1 wherein the items of content comprise samples of products or services offered in the selection of the at least one of products and services.

4. The method of claim 1 wherein the items of content comprise information pertaining to products or services offered in the selection of the at least one of products and services.

5. The method of claim 1 further comprising enabling another user to provide at least a portion of the monetary value of the user interaction with the specific item of content.

6. The method of claim 1 wherein the monetary value is a discount;

7. The method of claim 1 wherein the items of content represent the products;

8. The method of claim 1 wherein the items of content comprise information regarding schools.

9. A computer-implemented method used in connection with a web site offering of at least one of products and services for a monetary value comprising:
enabling a customer communicating with the web site over the Internet to interact with at least one product or service available through the web site;
determining a measure of the customer interaction with the at least one electronic product or service available through the web site;
determining a discount available to the customer based on the determined measure of the interaction; and
enabling the customer to purchase at least one of the products or services available through the web site for a price adjusted in accordance with the determined discount.

10. The method of claim 9 further comprising at least partially eliminating the discount if the customer exits the web site without making a purchase.

11. The method of claim 9 wherein the customer purchases the product or service that the customer has interacted with.

12. The method of claim 11 wherein the product or service that the customer interacts with is a software product or service.

13. The method of claim 11 wherein the customer is presented with fluctuating price for the product or service as the customer interacts with the product or service.

14. The method of claim 12 wherein the product or service that the customer interacts with is a computer game and the step of interacting comprises playing the game.

15. The method of claim 14 wherein the step of determining a measure of the customer interaction comprises determining a score earned by the customer as a result of playing the game.

16. The method of claim 14 wherein the step of determining a measure of the customer interaction comprises determining a score earned by the customer as a result of playing the game within a time limit.

17. The method of claim 15 wherein the step of determining a discount comprises making the discount proportional to the score up to a monetary limit.

18. A computer-implemented method for determining whether an individual and an organization are compatible comprising:
retrieving from memory a profile of the individual comprising stored characteristics of the individual;
retrieving a stored profile of the organization comprising fitness criteria adopted by the organization; and
determining a measure of fitness of the individual and the organization by applying the fitness criteria to the characteristics of the individual.

19. The method of claim 18 further comprising determining if there is a match between the individual and the organization based on the measure of fitness.

20. The method of claim 19 wherein the fitness criteria includes a computational formula.

21. The method of claim 20 wherein the formula includes conditional statements.

22. The method of claim 20 wherein the step of determining the measure of fitness further comprises applying the formula specified as the fitness criteria to values included in the characteristics of the individual.

23. The method of claim 19 wherein the organization is a school.

24. The method of claim 19 wherein the organization is an employer.

25. The method of claim 19 further comprising providing the determination if there is compatibility between the individual and the organization to the individual over the Internet.

26. The method of claim 19 further comprising providing the determination if there is a match to the organization over the Internet.

27. A method of providing advertisement to a user communicating with an advertising entity over a network, comprising:
sending e-mail containing an advertisement message specifying a monetary value associated with the message, wherein the monetary value is displayed before the user is capable of reading the advertisement;
receiving a response from the user indicating that the user has opened the e-mail; and
transferring the monetary value specified in the e-mail to the account of the user.

28. The method of claim 27 further comprising specifying an expiration date after which opening the e-mail does not cause transferring of the monetary value to the user's account.

29. A method of determining a path for an individual that would lead to acceptance of the individual to a desired organization, comprising:
receiving over the Internet an identification of the desired organization;
retrieving a profile of the individual;
retrieving stored data relating to paths that lead to acceptance to the desired organization; and
producing a path leading to the acceptance to the desired organization based on the user profile and the stored data relating to the paths that lead to the acceptance to the desired organization.

30. The method of claim 29 wherein the organization is a school.

31. The method of claim 29 wherein the organization is an employer.

32. The method of claim 29 wherein the path is a career path;

33. The method of claim 32 wherein the career path is educational career path.

34. The method of claim 29 wherein the stored data relating to the paths that lead to the acceptance to the desired organization comprise rules provided by one or more experts.

35. The method of claim 29 wherein the stored data relating to the paths that lead to acceptance to the desired organization comprises stored histories of individuals previously accepted to the organization.

36. The method of claim 29 wherein the step of producing a path leading to the acceptance comprising retrieving an expert system rule relating to the acceptance to the organization and evaluating and executing the rule.

37. A computer system comprising:
software for enabling a user to access a selection of items of content over the Internet;
software for enabling the user to choose a specific item of content from the items of content available in the selection of the items of content;
software for enabling the user to access the specific item of content;
enabling the user to interact with the specific item of content;
software for determining a monetary value of the user interaction with the specific item of content;
software for enabling the user to access over the Internet a selection of at least one of products and services;
software for enablibg the user to choose a specific product or service available in the selection of the at least one of products and services;
software for enabling the user to purchase the specific product or service; and
software for applying at least a portion of the monetary value of the user interaction with the specific item of content towards the purchase of the specific product or service available in the selection of the at least one of products and services.

38. The system of claim 37 wherein the items of content comprise at least one of educational and cultural materials.

39. The system of claim 37 wherein the items of content comprise samples of products or services offered in the selection of the at least one of products and services.

40. The system of claim 37 wherein the items of content comprise information pertaining to products or services offered in the selection of the at least one of products and services.

41. The system of claim 37 wherein the monetary value is a discount;

42. The system of claim 37 wherein the items of content represent the products;

43. The system of claim 37 wherein the items of content comprise information regarding schools.

44. A computer system supporting a web site offering of at least one of products and services for a monetary value comprising:
software for enabling a customer communicating with the web site over the Internet to interact with at least one product or service available through the web site;
software for determining a measure of the customer interaction with the at least one electronic product or service available through the web site;
software for determining a discount available to the customer based on the determined measure of the interaction; and
software for enabling the customer to purchase at least one of the products or services available through the web site for a price adjusted in accordance with the determined discount.

45. The system of claim 44 wherein the discount if the customer who exits the web site without making a purchase is at least partially eliminated.

46. The system of claim 44 wherein the customer purchases the product or service that the customer has interacted with.

47. The system of claim 46 wherein the product or service that the customer interacts with is a software product or service.

48. The system of claim 47 further comprising software for presenting a customer with fluctuating price for the product or service as the customer interacts with the product or service.

49. The system of claim 47 wherein the product or service that the customer interacts with is a computer game and interacting comprises playing the game.

50. The system of claim 47 wherein the discount is proportional to the score up to a monetary limit.

51. A computer system that determines whether an individual and an organization are compatible comprising:
software supporting interaction with users over the Internet
software for retrieving from memory a profile of the individual comprising stored characteristics of the individual;
software for retrieving a stored profile of the organization comprising fitness criteria adopted by the organization; and
software for determining a measure of fitness of the individual and the organization by applying the fitness criteria to the characteristics of the individual.

52. The system of claim 51 further comprising software for determining if there is a match between the individual and the organization based on the measure of fitness.

53. The system of claim 52 wherein the fitness criteria includes a computational formula.

54. The method of claim 53 wherein the formula includes conditional statements.

55. The system of claim 52 wherein the organization is a school.

56. The system of claim 52 wherein the organization is an employer.

57. A computer system for determining a path for an individual that would lead to acceptance of the individual to a desired organization, comprising:
software for receiving over the Internet an identification of the desired organization;
software for retrieving a profile of the individual;
software for retrieving stored data relating to paths that lead to acceptance to the desired organization; and
software for producing a path leading to the acceptance to the desired organization based on the user profile and the stored data relating to the paths that lead to the acceptance to the desired organization.

58. The system of claim 57 wherein the organization is a school.

59. The system of claim 57 wherein the organization is an employer.

60. The system of claim 57 wherein the path is a career path;

61. The system of claim 57 wherein the career path is educational career path.

62. The method of claim 58 wherein the software for producing the path leading to the acceptance comprises an expert system.
